(19) United States
(12) Patent Application Publication
(10) Pub. No.: US 2026/0269883 A1
(43) Pub. Date: Sep. 10, 2026

(54) ENHANCED NETWORK-ASSISTED SIGNALING FOR MULTI-USER MULTIPLE INPUT MULTIPLE OUTPUT ERCEIVERS IN WIRELESS COMMUNICATIONS

(71) Applicant: INTEL CORPORATION, Santa Clara, CA (US)

(72) Inventors: In-Seok HWANG, Santa Clara, CA (US); Hua LI, Beijing (CN); Meng ZHANG, Beijing (CN); Andrey CHERVYAKOV, Maynooth (IE); Rui HUANG, Beijing (CN)

(73) Assignee: INTEL CORPORATION, Santa Clara, CA (US)

(21) Appl. No.: 19/164,134

(22) PCT Filed: Apr. 8, 2024
(86) PCT No.: PCT/US2024/023571

§ 371 Date: Sep. 10, 2025

Related U.S. Application Data
(60) Provisional application No. 63/495,206, filed on Apr. 10, 2023.

(51) Int. Cl. H04B 7/0452; H04L 5/00; H04W 72/0446; H04W 72/0453; H04W 72/231; H04W 76/20

(52) U.S. Cl. CPC H04B 7/0452; H04L 5/0044; H04L 5/0051; H04W 72/0446; H04W 72/0453; H04W 72/231; H04W 76/20

(57) ABSTRACT

This disclosure describes systems, methods, and devices for receiving network assisted multi-user multiple input multiple output (MU-MIMO) signaling. A user equipment (UE) device may decode a MU-MIMO set-up field in a radio resource control (RRC) message sent from a Next Generation NodeB device; determine, based on at least two bits in the MU-MIMO set-up field, that a MU-MIMO transmission is enabled; and determine, based on that least two bits, a modulation scheme for co-scheduled UE devices.

### CROSS-REFERENCE TO RELATED PATENT APPLICATION(S)

This application claims the benefit of U.S. Provisional Application No. 63/495,206, filed Apr. 10, 2023, the disclosure of which is incorporated herein by reference as if set forth in full.

### TECHNICAL FIELD

This disclosure generally relates to systems and methods for wireless communications and, more particularly, to network-assisted signaling for multi-user multiple input multiple output (MU-MIMO) receivers.

### BACKGROUND

Wireless devices are becoming widely prevalent and are increasingly using wireless channels. The 3^{rd} Generation Partnership Program (3GPP) is developing one or more standards for wireless communications.

### BRIEF DESCRIPTION OF THE DRAWINGS

FIG. 1 is a network diagram illustrating an example network environment, in accordance with one or more example embodiments of the present disclosure.

FIG. 2 is an example multi-user multiple input multiple output (MU-MIMO) transmission, in accordance with one or more example embodiments of the present disclosure.

FIG. 3 illustrates a MU-MIMO scenario in which a number of code division multiplexing (CDM) groups without data is one, the antennae port for a target user equipment is AP1000, and the antenna port for an interference user equipment is AP1001, in accordance with one or more example embodiments of the present disclosure.

FIG. 4 illustrates a MU-MIMO scenario in which a number of CDM groups without data is two, the antennae ports for a target user equipment are AP1000 and AP1001, and the antenna ports for an interference user equipment are AP1002 and AP1003, in accordance with one or more example embodiments of the present disclosure.

FIG. 5 illustrates example non-aligned allocations under a single resource block transition per layer, in accordance with one or more example embodiments of the present disclosure.

FIG. 6 illustrates a flow diagram of illustrative process for network-assisted signaling for MU-MIMO receivers, in accordance with one or more example embodiments of the present disclosure.

FIG. 7. illustrates a network, in accordance with one or more example embodiments of the present disclosure.

FIG. 8 schematically illustrates a wireless network, in accordance with one or more example embodiments of the present disclosure.

FIG. 9 is a block diagram illustrating components, in accordance with one or more example embodiments of the present disclosure.

FIG. 10 illustrates a network, in accordance with one or more example embodiments of the present disclosure.

FIG. 11 illustrates a simplified block diagram of artificial (AI)-assisted communication between a user equipment and a radio access network, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Wireless devices may operate as defined by technical standards. For cellular telecommunications, the 3^{rd} Generation Partnership Program (3GPP) define communication techniques, including for multi-user multiple-input multiple-output (MU-MIMO) communications. To increase the download data throughput, a base station simultaneously generates multiple beams for multiple users with multiple antenna arrays. This technology is known as MU-MIMO transmission.

A user equipment (UE) demodulates the received signals by advanced receiver such as reduced maximum likelihood (R-ML) receiver. To perform this receiver signal processing, the UE needs to know the information of the other user's parameters related on demodulation reference signals (DMRS) as well as modulation order and number of layers of other users. The UE may use either blind detection on these parameters at the cost of complexity and/or performance degradation from detection error or network-assisted signaling, which informs the UE of the other user's parameter at the cost of signaling overhead.

The network signaling scheme needs to be designed to minimize the signaling overhead while delivering the essential parameter information. Depending on the nature of the parameter, some parameters need to be signaled per each transmission, such as modulation order and number of layers, of which some parameters are semi-statically configured. For some parameters, the desired user parameters may be assumed, or rules may be formulated to avoid signaling overhead.

The present disclosure provides the enhanced signaling scheme for MU-MIMO receivers at the UE side, and designs a framework for relaxing downlink MU-MIMO scheduler restrictions to utilize resources more efficiently. Until now, in 3GPP, the work has focused on cases where all multi-user allocation shares the same time-frequency resource, but this sharing may not be desirable considering different sizes of downloaded data per different users.

In MU-MIMO, a gNB may transmit data to paired UEs. A gNB with n transmitter antennae may transmit up to n total layers. If the UE may receive up to four layers of its own data with four receiver antennae, and a base station may have four transmitter antennae, then there are many combinations with which to send data with a given resource. Table 1 below shows the possible combinations in this scenario. When the UE has two receiver antennae, then the bolded combinations in Table 1 would not be possible. When there are three UEs in the MU-MIMO scenario, may include more combinations, including all two-UE cases, as shown in Table 2 below.

TABLE 1
MIMO Layers for two UE layers with four receiver antennae UEs

| Total MIMO | |
|---|---|
| layers | (UE1 layer, UE2 layer) with 4 Rx. UE |
| 1 | (1, 0), (0, 1) |
| 2 | (1, 1), (2, 0), (0, 2) |
| 3 | (1, 2), (2, 1), (3, 0), (0, 3) |
| 4 | (1, 3), (2, 2), (3, 1), (4, 0), (0, 4) |

TABLE 2
MIMO Layers for three UE layers with four receiver antennae UEs

| Total MIMO | |
|---|---|
| layers | (UE1 layer, UE2 layer, UE3 layer) with 4 Rx. UE |
| 1 | (1, 0, 0), (0, 1, 0), (0, 0, 1) |
| 2 | (1, 1, 0), (0, 1, 1), (1, 0, 1),(2, 0, 0), (0, 2, 0), |
| | (0, 0, 2) |
| 3 | (1, 1, 1), (2, 1, 0), (1, 2, 0), . . . , (3, 0, 0), |
| | (0, 3, 0), (0, 0, 3) |
| 4 | (1, 1, 2), (1, 2, 1), . . . , (0, 2, 2), . . . , (4, 0, 0), |
| | (0, 4, 0), (0, 0 4) |

Table 3 below shows required parameters on another UE's signals for a R-ML receiver.

TABLE 3
MU-MIMO Information Element for R-ML receiver

| Information on co-scheduled UEs | Signaling Scheme |
|---|---|
| 1) Presence of MU-MIMO interfering | (Port Presence and Modulation Order) |
| layer | Signaling |
| 2) DMRS sequence information | Assumed fixed rule under MU-MIMO set- |
| (n_{scid} = 0 or 1) | up |
| 3) DMRS port | (Port Presence and Modulation Order) |
| 4) Modulation order per layer | Signaling |
| 5) Precoding granularity | (Port Presence and Modulation Order) |
| 6) TDRA (Time domain resource | Signaling |
| allocation) pattern | Assumed as target UE under MU-MIMO |
| 7) FDRA (Frequency domain resource | set-up |
| allocation) pattern | Assumed same as target under MU- |
| | MIMO set-up |
| | Assumed same as target under MU- |
| | MIMO set-up |

Table 3 provides an information element that may be used to provide a set of assistance information for R-ML receivers with enhanced inter-user interference suppression for MU-MIMO transmissions. The information element may be signaled from the network to the UE by RRC signaling.

### Presence of MU-MIMO Transmission

The information on the presence of MU-MIMO transmission or other UE's DMRS port can be achieved by either blind detection or network signaling of “Zero” constellation. Once the signaling of the modulation order of the interfering layer is determined, it would be effective to design the format jointly. For example, at least 2-bit information DCI may be defined as below:
00: No interference presence.
01: Interference with QPSK.
10: Interference with 16QAM.
11: Interference with 64QAM or 256 QAM.

The same indicator of ‘11’ for 64 QAM/256 QAM is motivated by the fact that the 256QAM is very rare and even worse in MU-MIMO allocation.

### DMRS Port of Interfering Layer

Once the signaling of the modulation order of the interfering layer is determined, the port information is encoded by the cyclic indexing with respect to target UE's port without adding additional signaling overhead.

### DL MU-MIMO Set-Up Indicator in BWP Configuration

A 1-bit DL MU-MIMO set-up indicator may be introduced in a in BWP configuration. If the bit is set, UE can make the following MU-MIMO favourable assumptions among paired UEs including:
Same PDSCH allocation region between paired users.
Same precoding granularity, fixed allocation rules on n_{scid}.
Same DMRS-DownlinkConfig.

DMRS-DownlinkConfig :: = SEQUENCE {

| | | |
|---|---|---|
| dmrs-Type | ENUMERATED {type2} | OPTIONAL, -- Need S |
| dmrs-AdditionalPosition | ENUMERATED {pos0, pos1, pos3} | OPTIONAL, -- Need S |
| maxLength | ENUMERATED {len2} | OPTIONAL, -- Need S |
| scramblingID0 | INTEGER (0..65535) | OPTIONAL, -- Need S |
| scramblingID1 | INTEGER (0..65535) | OPTIONAL, -- Need S |

| | |
|---|---|
| phaseTrackingRS SetupRelease {PTRS-DownlinkConfig} | OPTIONAL, -- Need M |

...,
[[

| | | |
|---|---|---|
| dmrs-Downlink-r16 | ENUMERATED {enabled} | OPTIONAL -- Need R |

```
  ]]
  }
```

The DMRS-DownlinkConfig needs to be aligned for the same DMRS symbol length, positions, and dmrs-Type to guarantee orthogonality between DMRS ports. For (scramblingID0, scrablingID1), the scope may be limited to a total of four layers with at most two CDM groups. Thus, at most two scrambling IDs may be set for the randomization purpose, which implies that it can be assumed that the same set may apply for all users at least in the same serving cell. The necessity of BWP specific signaling configuration can be justified by the grouping of users depending on their mobility or number of Rx antennas and apply different maxMIMOlayers or additional DMRS to each BWP.

### Port Presence and Modulation Order Signaling Format

The signaling format for {Presence of interfering MU-MIMO layer, DMRS port and Modulation Order} may be jointly defined. One of the possible design examples is as below in Table 4, and uses minimum signaling overhead for modulation order signaling of 2 bits 6 bits when maxMIMO-Layers=2 or 4 where maxMIMO-Layers indicates the maximum number of MIMO layers to be used for PDSCH in DL BWP.

TABLE 4
Signaling Format for {Presence of interfering MU-
MIMO layer, DMRS port and Modulation Order}

| | | DCI signaling Info. | Antenna |
|---|---|---|---|
| | | (Port Presence and | Port = 1000 + |
| Signaling Overhead | | Modulation Order) | DMRS Port (P) |
| 2 bits | maxMIMO- | 00: No interference presence | P = {0, 1} |
| | Layers = 2 | 01: Interference with QPSK | |
| | | 10: Interference with 16QAM | |
| | | 11: Interference with 64QAM or | |
| | | 256 QAM | |
| 6 bits | maxMIMO- | For 3 interfering ports in cyclic | P = {0, 1, 2, 3} |
| | Layers = 4 | order from desired layer, each 2 | |
| | | bits represent as | |
| | | 00: No interference presence | |
| | | 01: Interference with QPSK | |
| | | 10: Interference with 16QAM | |
| | | 11: Interference with 64QAM or | |
| | | 256 QAM | |

Fixed Rule for DMRS Sequence Information n_{SCID}∈{0, 1} in DCI Format
1) For Rel-15 UE, it is desirable to assign different DMRS sequence initialization seed, n_{SCID}∈{0, 1} between different CDM group users i.e FDM-wise DMRS multiplexed users.
2) Rel-16 introduced the way to reduce PAPR when single user is assigned multiple CDM groups (higher rank case). In this case, two different scramblingID0 and scramblingID1 are applied to even and odd CDM groups when n_{SCID}=0 (odd and even CDM groups when n_{SCID}=1).
Thus, under the fixed the rule 1) and 2), the desired UE can know the DMRS scrambling seed cᵢₙᵢₜ for other user's ports by own n_{SCID}.

The role of DMRS scrambling ID n_{SCID} ∈{0, 1} in 5G NR is as follows:

$${c}_{init} = ( {2}^{17} ( {N}_{symb}^{slot} {n}_{s , f}^{μ} + l + 1 ) ( 2 {N}_{ID}^{{\overline{n}}_{SCID}^{λ}} - 1 ) + {2}^{17} ⌊ \frac{\overline{λ}}{2} ⌋ + 2 {N}_{ID}^{{\overline{n}}_{SCID}^{λ}} + {\overline{n}}_{SCID}^{\overline{λ}} ) mod {2}^{31} ,$$

where l is the OFDM symbol number within the slot,

$${n}_{s , f}^{μ}$$

is the slot number within a frame,

$${N}_{ID}^{0} , {N}_{ID}^{1} ∈ \{ 0 , 1 , … , 65535 \}$$

are given by the higher-layer parameters scramblingID0 and scramblingID1, respectively, in the DMRS-DownlinkConfig IE if provided, and the PDSCH is scheduled by PDCCH using DCI format 1_1 or 1_2 with the CRC scrambled by C-RNTI, MCS-C-RNTI, or CS-RNTI,

$${N}_{ID}^{0} ∈ \{ 0 , 1 , … , 65535 \}$$

is given by the higher-layer parameter scramblingID0 in the DMRS-DownlinkConfig IE if provided and the PDSCH is scheduled by PDCCH using DCI format 1_0 with the CRC scrambled by C-RNTI, MCS-C-RNTI, or CS-RNTI,

$${N}_{ID}^{{\overline{n}}_{SCID}^{λ}} = {N}_{ID}^{c e l l}$$

otherwise;

$${\overline{n}}_{SCID}^{\overline{λ}}$$

and λ̅ are given by:

If the higher-layer parameter dmrs-Downlink in the DMRS-DownlinkConfig IE is provided:

$${\overline{n}}_{SCID}^{\overline{λ}} = \{ \begin{matrix}{n}_{SCID} & λ = 0 or λ = 2 \\ 1 - {n}_{SCID} & λ = 1\end{matrix}$$

$$\overline{λ} = λ$$

where λ is the CDM group,

otherwise by:

$${\overline{n}}_{SCID}^{\overline{λ}} = {n}_{SCID}$$

$$\overline{λ} = 0 .$$

### Considerations for Non-Aligned PDSCH Scenario

Observation 1: Due to the freedom in allocation in terms of RB region, modulation order and number of layer, some restriction such as x-times of PRB-bundling size or RBG-size granularity may be needed in PDSCH allocation.

Observation 2. Even with the RB allocation granularities, it would be hard to use network assisted signaling in a non-aligned scenario.

Observation 3. One of the possible ways for non-aligned RB allocation is to control the number of allocation transition in each layer. If not allowed, it would be a fully aligned scenario.

As an example, a non-aligned allocation may occur when only single allocation transition is allowed in each layer. The advantage of this approach can be summarized as below.

$$Total number of partitions is limited to {N}_{total partitions} <= {N}_{transit} + 1 + {N}_{transit} * ( {N}_{Int . layer} - 1 ) \qquad 1 )$$

$$Total max . signalling overhead = {N}_{bit . Mod . order , presence} * ( {N}_{transit} + 1 ) * {N}_{Int . layer} + {N}_{bit , RB index} * ( {N}_{total partitions} - 1 ) , \qquad 2 )$$

where N_{Int.layer} is # of interfering layers and Nₜᵣₐₙₛᵢₜ is the number of RB allocation transitions per each interfering layer. The RB index of each partition region may be detected with blind detection. For Case (a) with four layers (1+1+1+1), there are four partitions and six interfering users. If blind detection works for partition boundary detection, two times of signaling overhead for modulation order information is required compared with the aligned PDSCH allocation case.

Another proposal is for RAN4 to investigate the performance of blind detection of partition region in terms of required PRBs.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

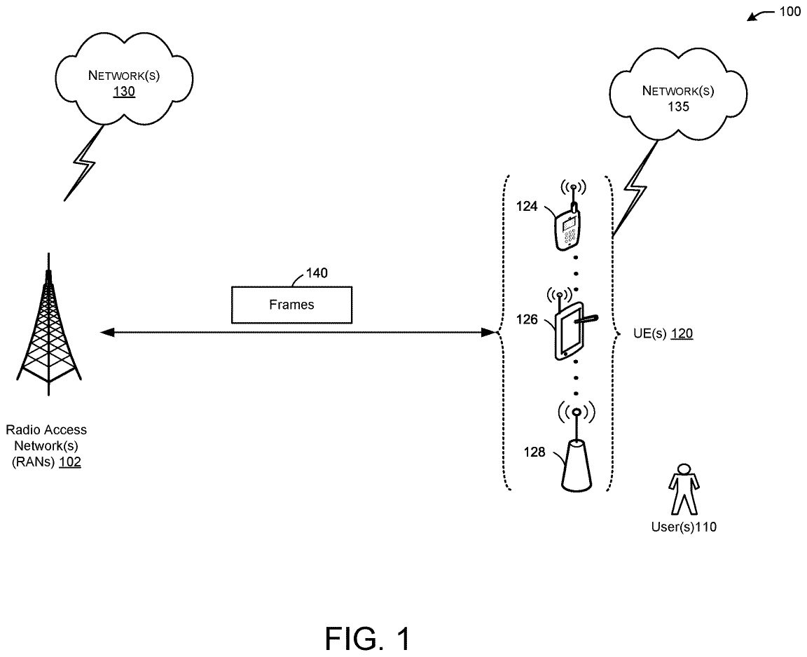

FIG. 1 is a network diagram illustrating an example network environment 100, in accordance with one or more example embodiments of the present disclosure.

Wireless network 100 may include one or more UEs 120 and one or more RANs 102 (e.g., gNBs), which may communicate in accordance with 3GPP communication standards. The UE(s) 120 may be mobile devices that are non-stationary (e.g., not having fixed locations) or may be stationary devices.

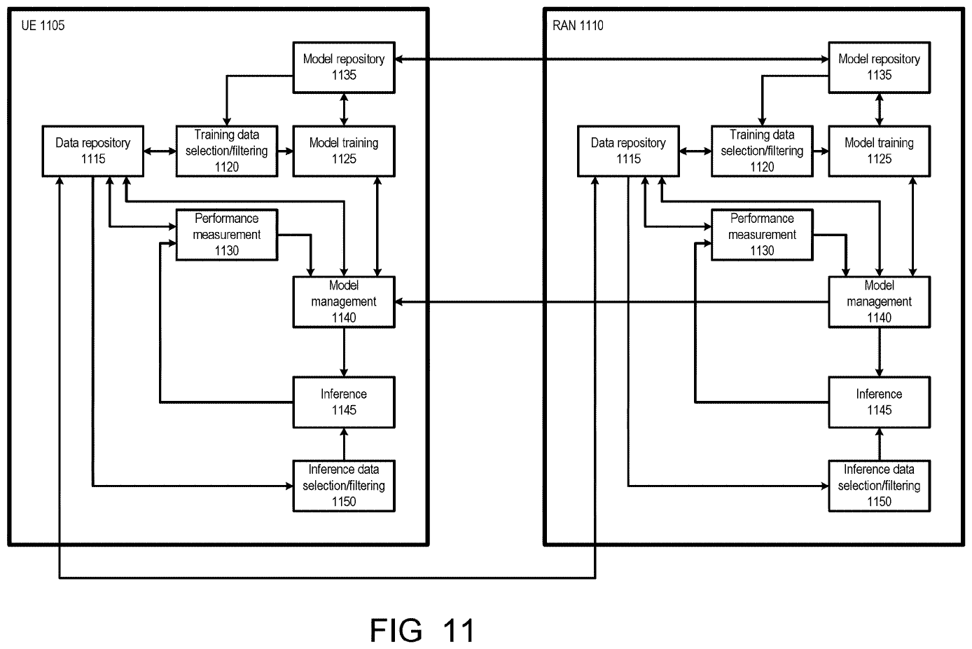

In some embodiments, the UEs 120 and the RANs 102 may include one or more computer systems similar to that of FIGS. 11-13.

One or more illustrative UE(s) 120 and/or RAN(s) 102 may be operable by one or more user(s) 110. A UE may take on multiple distinct characteristics, each of which shape its function. For example, a single addressable unit might simultaneously be a portable UE, a quality-of-service (QoS) UE, a dependent UE, and a hidden UE. The UE(s) 120 (e.g., 124, 126, or 128) and/or RAN(s) 102 may include any suitable processor-driven device including, but not limited to, a mobile device or a non-mobile, e.g., a static device. For example, UE(s) 120 may include, a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

Any of the UE(s) 120 (e.g., UEs 124, 126, 128), and UE(s) 120 may be configured to communicate with each other via one or more communications networks 130 and/or 135 wirelessly or wired. The UE(s) 120 may also communicate peer-to-peer or directly with each other with or without the RAN(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, cellular networks. In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the UE(s) 120 (e.g., UE 124, 126, 128) and RAN(s) 102 may include one or more communications antennas. The one or more communications antennas may be any suitable type of antennas corresponding to the communications protocols used by the UE(s) 120 (e.g., UEs 124, 126 and 128), and RAN(s) 102. Some non-limiting examples of suitable communications antennas include cellular antennas, 3GPP family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the UEs 120 and/or RAN(s) 102.

Any of the UE(s) 120 (e.g., UE 124, 126, 128), and RAN(s) 102 may be configured to perform directional transmission and/or directional reception in conjunction with wirelessly communicating in a wireless network. Any of the UE(s) 120 (e.g., UE 124, 126, 128), and RAN(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the UE(s) 120 (e.g., UE 124, 126, 128), and RAN(s) 102 may be configured to perform any given directional transmission towards one or more defined transmit sectors. Any of the UE(s) 120 (e.g., UE 124, 126, 128), and RAN(s) 102 may be configured to perform any given directional reception from one or more defined receive sectors.

MIMO beamforming in a wireless network may be accomplished using RF beamforming and/or digital beamforming. In some embodiments, in performing a given MIMO transmission, UE 120 and/or RAN(s) 102 may be configured to use all or a subset of its one or more communications antennas to perform MIMO beamforming.

Any of the UE 120 (e.g., UE 124, 126, 128), and RAN(s) 102 may include any suitable radio and/or transceiver for transmitting and/or receiving radio frequency (RF) signals in the bandwidth and/or channels corresponding to the communications protocols utilized by any of the UE(s) 120 and RAN(s) 102 to communicate with each other. The radio components may include hardware and/or software to modulate and/or demodulate communications signals according to pre-established transmission protocols. The radio components may further have hardware and/or software instructions to communicate via one or more 3GPP protocols and using 3GPP bandwidths. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one or more embodiments, and with reference to FIG. 1, one or more of the UEs 120 may exchange frames 140 with the RANs 102. The frames 140 may include UL and DL frames, including MU-MIMO frames, signaling for MU-MIMO frames (e.g., DCI, RRC, etc.), and other frames as described herein.

It is understood that the above descriptions are for purposes of illustration and are not meant to be limiting.

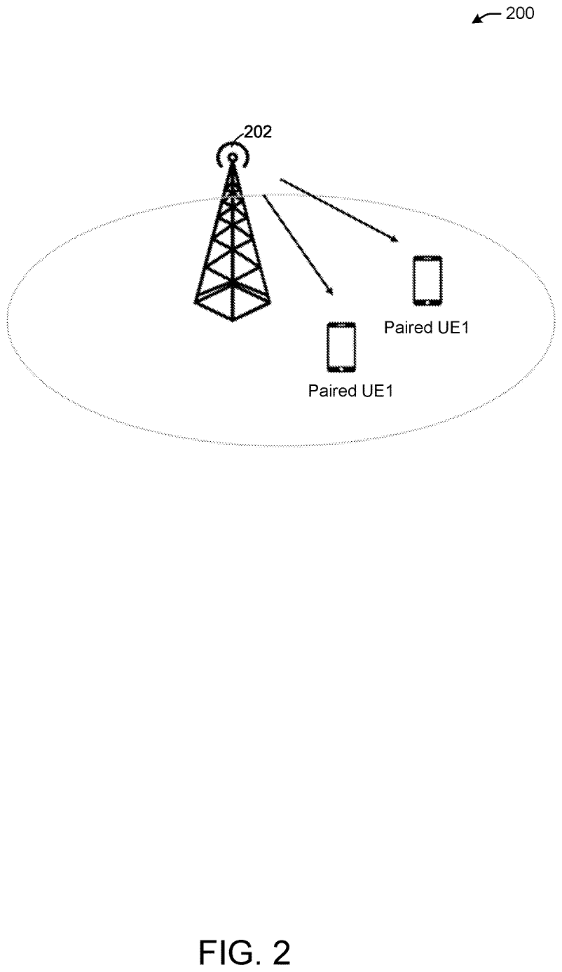

FIG. 2 is an example multi-user multiple input multiple output (MU-MIMO) transmission 200, in accordance with one or more example embodiments of the present disclosure.

Referring to FIG. 2, a gNB 202 may transmit data using MU-MIMO to multiple UEs paired with the gNB 202 (e.g., paired UE1, paired UE2). The gNB 202 with Ntx antennas can transmit up to Ntx total layers. If a paired UE can receive up to four layers of data with four receive (Rx) antennas, and the gNB 202 has four transmit antennas, then there are many possible combinations that may be used to send data with the given resource. The combinations are shown in Tables 1 and 2 above.

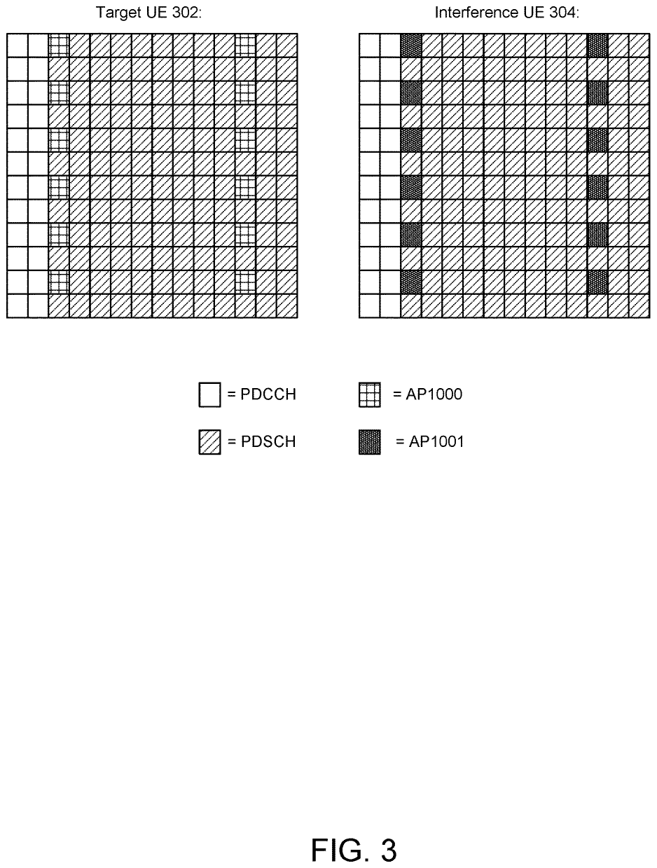

FIG. 3 illustrates a MU-MIMO scenario in which a number of code division multiplexing (CDM) groups without data is one, the antennae port for a target user equipment is AP1000, and the antenna port for an interference user equipment is AP1001, in accordance with one or more example embodiments of the present disclosure.

In particular, FIG. 3 shows an example of two layers with (1,1) for target UE 302 and interference UE 304, antenna port (AP) number=1000+DMRS port (P)=0, 1. The number of CDM group without data is the number of RE groups, which is not used for data transmission and used for DMRS signals. The DMRS Port 0 and 1 share the same position but covered with different orthogonal code division multiplexed (CDM) codes for adjacent DMRS REs i.e [+1+1] for port 0 and [+1-1] for port 1.

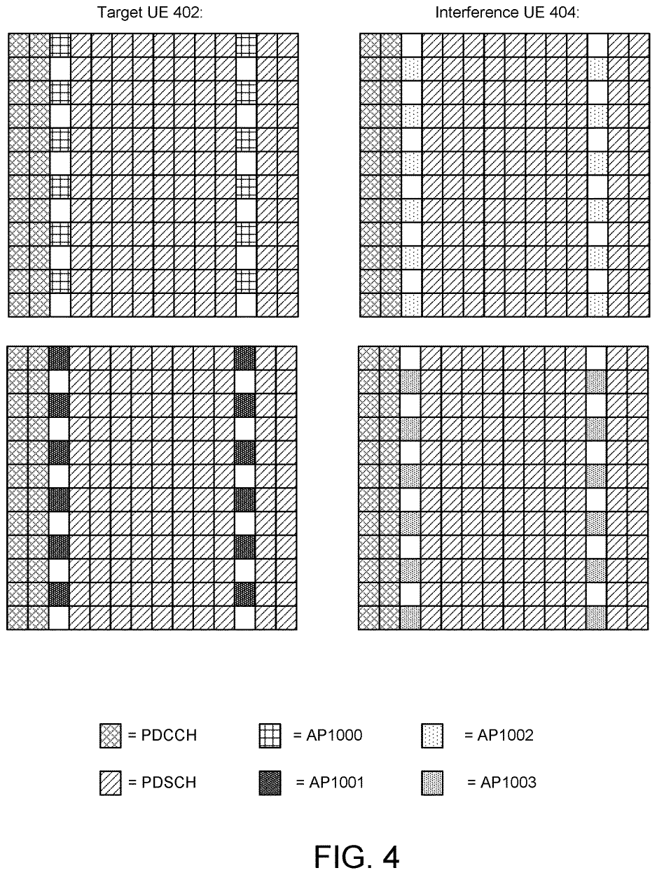

FIG. 4 illustrates a MU-MIMO scenario in which a number of CDM groups without data is two, the antennae ports for a target user equipment are AP1000 and AP1001, and the antenna ports for an interference user equipment are AP1002 and AP1003, in accordance with one or more example embodiments of the present disclosure.

In particular, FIG. 4 shows an example of four layers with (2, 2) for a target UE 402 and an interference UE 404. The antenna port (AP) number=1000+DMRS port (P)=0, 1, 2, 3. Different CDM groups are frequency division multiplexed (e.g., FDMed).

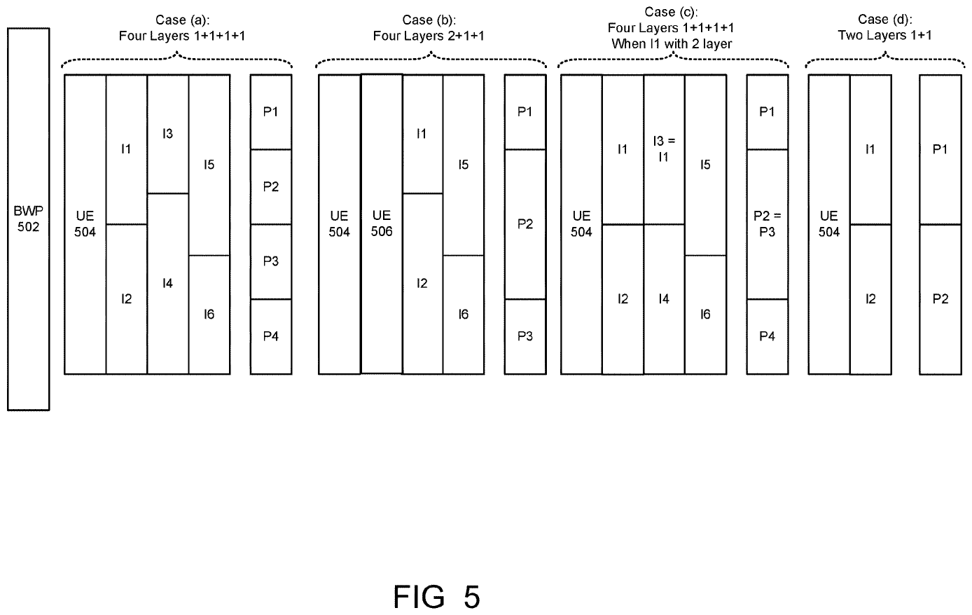

FIG. 5 illustrates example non-aligned allocations under a single resource block transition per layer, in accordance with one or more example embodiments of the present disclosure.

Referring to FIG. 5, for case (a), there are four partitions (e.g., P1-P4) and six interfering users (e.g., I1-I6) in a BWP 502, and there is one target UE 504.

For case (b), there are two target UEs (e.g., UE 504 and UE 506), three partitions (e.g., P1-P3), and four interfering users in the BWP 502.

For case (c), there is one target UE 504, and there are three partitions, and six interfering users in the BWP 502.

For case (d), there is one target UE 504, and there are two partitions and two interfering users in the BWP 502.

The advantage of this approach can be summarized as below.

$$Total number of partitions is limited to {N}_{total partitions} <= {N}_{transit} + 1 + {N}_{transit} * ( {N}_{Int . layer} - 1 ) . \qquad 1 )$$

$$Total max . signalling overhead = {N}_{bit . Mod . order , presence} * ( {N}_{transit} + 1 ) * {N}_{Int . layer} + {N}_{bit , RB index} * ( {N}_{total partitions} - 1 ) , \qquad 2 )$$

where N_{Int.layer} is # of interfering layers and Nₜᵣₐₙₛᵢₜ is the number of RB allocation transitions per each interfering layer. The RB index of each partition region may be detected with blind detection.

If blind detection works well for partition boundary detection, two times of signaling overhead for modulation order information is required compared to an aligned PDSCH allocation case.

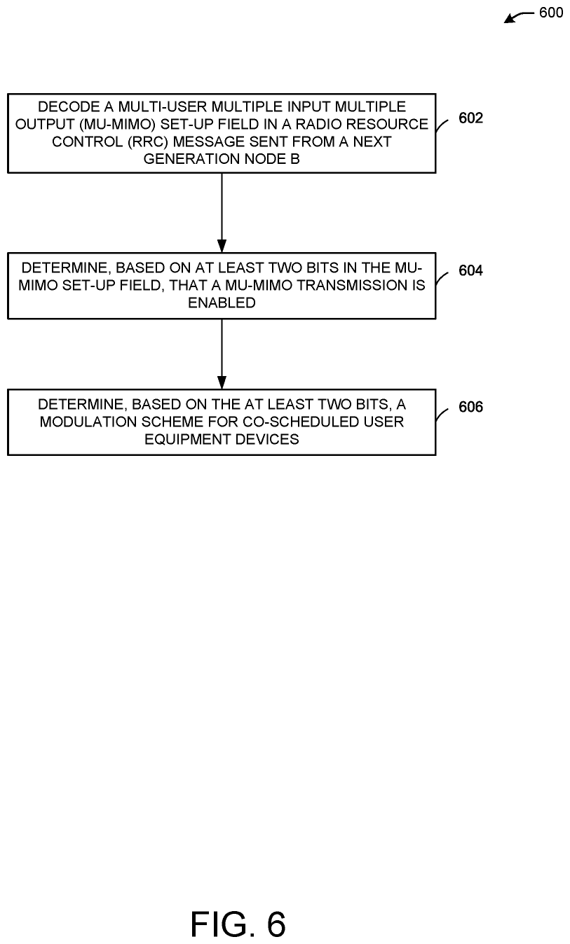

FIG. 6 illustrates a flow diagram of illustrative process 600 for network-assisted signaling for MU-MIMO receivers, in accordance with one or more example embodiments of the present disclosure.

At block 602, a UE device may decode a MU-MIMO set-up field received in a RRC message from a gNB. The MU-MIMO set-up field may include at least two bits to signal whether MU-MIMO transmissions are enabled and what the modulation scheme is for co-scheduled UEs, including the UE device.

At block 604, the device may determine, based on the at least two bits in the MU-MIMO set-up field, that a MU-MIMO transmission is enabled.

At block 606, the device may determine, based on the at least two bits, the modulation scheme for co-scheduled UE devices.

These embodiments are not meant to be limiting.

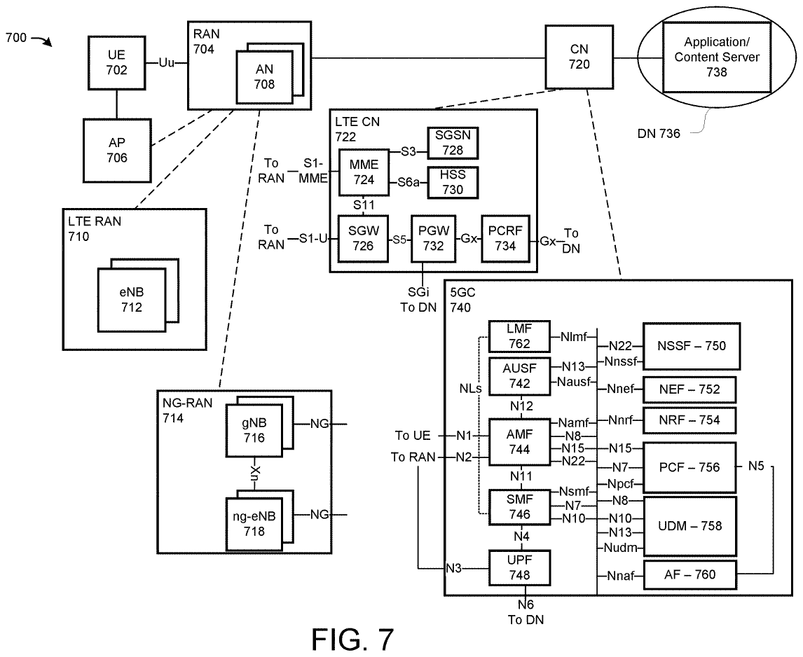

FIG. 7 illustrates a network 700 in accordance with various embodiments. The network 700 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 700 may include a UE 702, which may include any mobile or non-mobile computing device designed to communicate with a RAN 704 via an over-the-air connection. The UE 702 may be communicatively coupled with the RAN 704 by a Uu interface. The UE 702 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 700 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 702 may additionally communicate with an AP 706 via an over-the-air connection. The AP 706 may manage a WLAN connection, which may serve to offload some/all network traffic from the RAN 704. The connection between the UE 702 and the AP 706 may be consistent with any IEEE 802.11 protocol, wherein the AP 706 could be a wireless fidelity (Wi-Fi®) router. In some embodiments, the UE 702, RAN 704, and AP 706 may utilize cellular-WLAN aggregation (for example, LWA/LWIP). Cellular-WLAN aggregation may involve the UE 702 being configured by the RAN 704 to utilize both cellular radio resources and WLAN resources.

The RAN 704 may include one or more access nodes, for example, AN 708. AN 708 may terminate air-interface protocols for the UE 702 by providing access stratum protocols including RRC, PDCP, RLC, MAC, and L1 protocols. In this manner, the AN 708 may enable data/voice connectivity between CN 720 and the UE 702. In some embodiments, the AN 708 may be implemented in a discrete device or as one or more software entities running on server computers as part of, for example, a virtual network, which may be referred to as a CRAN or virtual baseband unit pool. The AN 708 be referred to as a BS, gNB, RAN node, eNB, ng-eNB, NodeB, RSU, TRxP, TRP, etc. The AN 708 may be a macrocell base station or a low power base station for providing femtocells, picocells or other like cells having smaller coverage areas, smaller user capacity, or higher bandwidth compared to macrocells.

In embodiments in which the RAN 704 includes a plurality of ANs, they may be coupled with one another via an X2 interface (if the RAN 704 is an LTE RAN) or an Xn interface (if the RAN 704 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 704 may each manage one or more cells, cell groups, component carriers, etc. to provide the UE 702 with an air interface for network access. The UE 702 may be simultaneously connected with a plurality of cells provided by the same or different ANs of the RAN 704. For example, the UE 702 and RAN 704 may use carrier aggregation to allow the UE 702 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 704 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 702 or AN 708 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 704 may be an LTE RAN 710 with eNBs, for example, eNB 712. The LTE RAN 710 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 704 may be an NG-RAN 714 with gNBs, for example, gNB 716, or ng-eNBs, for example, ng-eNB 718. The gNB 716 may connect with 5G-enabled UEs using a 5G NR interface. The gNB 716 may connect with a 5G core through an NG interface, which may include an N2 interface or an N3 interface. The ng-eNB 718 may also connect with the 5G core through an NG interface, but may connect with a UE via an LTE air interface. The gNB 716 and the ng-eNB 718 may connect with each other over an Xn interface.

In some embodiments, the NG interface may be split into two parts, an NG user plane (NG-U) interface, which carries traffic data between the nodes of the NG-RAN 714 and a UPF 748 (e.g., N3 interface), and an NG control plane (NG-C) interface, which is a signaling interface between the nodes of the NG-RAN 714 and an AMF 744 (e.g., N2 interface).

The NG-RAN 714 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 702 can be configured with multiple BWPs where each BWP configuration has a different SCS. When a BWP change is indicated to the UE 702, the SCS of the transmission is changed as well. Another use case example of BWP is related to power saving. In particular, multiple BWPs can be configured for the UE 702 with different amount of frequency resources (for example, PRBs) to support data transmission under different traffic loading scenarios. A BWP containing a smaller number of PRBs can be used for data transmission with small traffic load while allowing power saving at the UE 702 and in some cases at the gNB 716. A BWP containing a larger number of PRBs can be used for scenarios with higher traffic load.

The RAN 704 is communicatively coupled to CN 720 that includes network elements to provide various functions to support data and telecommunications services to customers/subscribers (for example, users of UE 702). The components of the CN 720 may be implemented in one physical node or separate physical nodes. In some embodiments, NFV may be utilized to virtualize any or all of the functions provided by the network elements of the CN 720 onto physical compute/storage resources in servers, switches, etc. A logical instantiation of the CN 720 may be referred to as a network slice, and a logical instantiation of a portion of the CN 720 may be referred to as a network sub-slice.

In some embodiments, the CN 720 may be an LTE CN 722, which may also be referred to as an EPC. The LTE CN 722 may include MME 724, SGW 726, SGSN 728, HSS 730, PGW 732, and PCRF 734 coupled with one another over interfaces (or “reference points”) as shown. Functions of the elements of the LTE CN 722 may be briefly introduced as follows.

The MME 724 may implement mobility management functions to track a current location of the UE 702 to facilitate paging, bearer activation/deactivation, handovers, gateway selection, authentication, etc.

The SGW 726 may terminate an Si interface toward the RAN and route data packets between the RAN and the LTE CN 722. The SGW 726 may be a local mobility anchor point for inter-RAN node handovers and also may provide an anchor for inter-3GPP mobility. Other responsibilities may include lawful intercept, charging, and some policy enforcement.

The SGSN 728 may track a location of the UE 702 and perform security functions and access control. In addition, the SGSN 728 may perform inter-EPC node signaling for mobility between different RAT networks; PDN and S-GW selection as specified by MME 724; MME selection for handovers; etc. The S3 reference point between the MME 724 and the SGSN 728 may enable user and bearer information exchange for inter-3GPP access network mobility in idle/active states.

The HSS 730 may include a database for network users, including subscription-related information to support the network entities' handling of communication sessions. The HSS 730 can provide support for routing/roaming, authentication, authorization, naming/addressing resolution, location dependencies, etc. An S6a reference point between the HSS 730 and the MME 724 may enable transfer of subscription and authentication data for authenticating/authorizing user access to the LTE CN 720.

The PGW 732 may terminate an SGi interface toward a data network (DN) 736 that may include an application/content server 738. The PGW 732 may route data packets between the LTE CN 722 and the data network 736. The PGW 732 may be coupled with the SGW 726 by an S5 reference point to facilitate user plane tunneling and tunnel management. The PGW 732 may further include a node for policy enforcement and charging data collection (for example, PCEF). Additionally, the SGi reference point between the PGW 732 and the data network 736 may be an operator external public, a private PDN, or an intra-operator packet data network, for example, for provision of IMS services. The PGW 732 may be coupled with a PCRF 734 via a Gx reference point.

The PCRF 734 is the policy and charging control element of the LTE CN 722. The PCRF 734 may be communicatively coupled to the app/content server 738 to determine appropriate QoS and charging parameters for service flows. The PCRF 732 may provision associated rules into a PCEF (via Gx reference point) with appropriate TFT and QCI.

In some embodiments, the CN 720 may be a 5GC 740. The 5GC 740 may include an AUSF 742, AMF 744, SMF 746, UPF 748, NSSF 750, NEF 752, NRF 754, PCF 756, UDM 758, and AF 760 coupled with one another over interfaces (or “reference points”) as shown. Functions of the elements of the 5GC 740 may be briefly introduced as follows.

The AUSF 742 may store data for authentication of UE 702 and handle authentication-related functionality. The AUSF 742 may facilitate a common authentication framework for various access types. In addition to communicating with other elements of the 5GC 740 over reference points as shown, the AUSF 742 may exhibit an Nausf service-based interface.

The AMF 744 may allow other functions of the 5GC 740 to communicate with the UE 702 and the RAN 704 and to subscribe to notifications about mobility events with respect to the UE 702. The AMF 744 may be responsible for registration management (for example, for registering UE 702), connection management, reachability management, mobility management, lawful interception of AMF-related events, and access authentication and authorization. The AMF 744 may provide transport for SM messages between the UE 702 and the SMF 746, and act as a transparent proxy for routing SM messages. AMF 744 may also provide transport for SMS messages between UE 702 and an SMSF. AMF 744 may interact with the AUSF 742 and the UE 702 to perform various security anchor and context management functions. Furthermore, AMF 744 may be a termination point of a RAN CP interface, which may include or be an N2 reference point between the RAN 704 and the AMF 744; and the AMF 744 may be a termination point of NAS (N1) signaling, and perform NAS ciphering and integrity protection. AMF 744 may also support NAS signaling with the UE 702 over an N3 IWF interface.

The SMF 746 may be responsible for SM (for example, session establishment, tunnel management between UPF 748 and AN 708); UE IP address allocation and management (including optional authorization); selection and control of UP function; configuring traffic steering at UPF 748 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 744 over N2 to AN 708; and determining SSC mode of a session. SM may refer to management of a PDU session, and a PDU session or “session” may refer to a PDU connectivity service that provides or enables the exchange of PDUs between the UE 702 and the data network 736.

The UPF 748 may act as an anchor point for intra-RAT and inter-RAT mobility, an external PDU session point of interconnect to data network 736, and a branching point to support multi-homed PDU session. The UPF 748 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 748 may include an uplink classifier to support routing traffic flows to a data network.

The NSSF 750 may select a set of network slice instances serving the UE 702. The NSSF 750 may also determine allowed NSSAI and the mapping to the subscribed S-NSSAIs, if needed. The NSSF 750 may also determine the AMF set to be used to serve the UE 702, or a list of candidate AMFs based on a suitable configuration and possibly by querying the NRF 754. The selection of a set of network slice instances for the UE 702 may be triggered by the AMF 744 with which the UE 702 is registered by interacting with the NSSF 750, which may lead to a change of AMF. The NSSF 750 may interact with the AMF 744 via an N22 reference point; and may communicate with another NSSF in a visited network via an N31 reference point (not shown). Additionally, the NSSF 750 may exhibit an Nnssf service-based interface.

The NEF 752 may securely expose services and capabilities provided by 3GPP network functions for third party, internal exposure/re-exposure, AFs (e.g., AF 760), edge computing or fog computing systems, etc. In such embodiments, the NEF 752 may authenticate, authorize, or throttle the AFs. NEF 752 may also translate information exchanged with the AF 760 and information exchanged with internal network functions. For example, the NEF 752 may translate between an AF-Service-Identifier and an internal 5GC information. NEF 752 may also receive information from other NFs based on exposed capabilities of other NFs. This information may be stored at the NEF 752 as structured data, or at a data storage NF using standardized interfaces. The stored information can then be re-exposed by the NEF 752 to other NFs and AFs, or used for other purposes such as analytics. Additionally, the NEF 752 may exhibit an Nnef service-based interface.

The NRF 754 may support service discovery functions, receive NF discovery requests from NF instances, and provide the information of the discovered NF instances to the NF instances. NRF 754 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 754 may exhibit the Nnrf service-based interface.

The PCF 756 may provide policy rules to control plane functions to enforce them, and may also support unified policy framework to govern network behavior. The PCF 756 may also implement a front end to access subscription information relevant for policy decisions in a UDR of the UDM 758. In addition to communicating with functions over reference points as shown, the PCF 756 exhibit an Npcf service-based interface.

The UDM 758 may handle subscription-related information to support the network entities' handling of communication sessions, and may store subscription data of UE 702. For example, subscription data may be communicated via an N8 reference point between the UDM 758 and the AMF 744. The UDM 758 may include two parts, an application front end and a UDR. The UDR may store subscription data and policy data for the UDM 758 and the PCF 756, and/or structured data for exposure and application data (including PFDs for application detection, application request information for multiple UEs 702) for the NEF 752. The Nudr service-based interface may be exhibited by the UDR to allow the UDM 758, PCF 756, and NEF 752 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 758 may exhibit the Nudm service-based interface.

The AF 760 may provide application influence on traffic routing, provide access to NEF, and interact with the policy framework for policy control.

In some embodiments, the 5GC 740 may enable edge computing by selecting operator/3^{rd} party services to be geographically close to a point that the UE 702 is attached to the network. This may reduce latency and load on the network. To provide edge-computing implementations, the 5GC 740 may select a UPF 748 close to the UE 702 and execute traffic steering from the UPF 748 to data network 736 via the N6 interface. This may be based on the UE subscription data, UE location, and information provided by the AF 760. In this way, the AF 760 may influence UPF (re)selection and traffic routing. Based on operator deployment, when AF 760 is considered to be a trusted entity, the network operator may permit AF 760 to interact directly with relevant NFs. Additionally, the AF 760 may exhibit an Naf service-based interface.

The data network 736 may represent various network operator services, Internet access, or third party services that may be provided by one or more servers including, for example, application/content server 738.

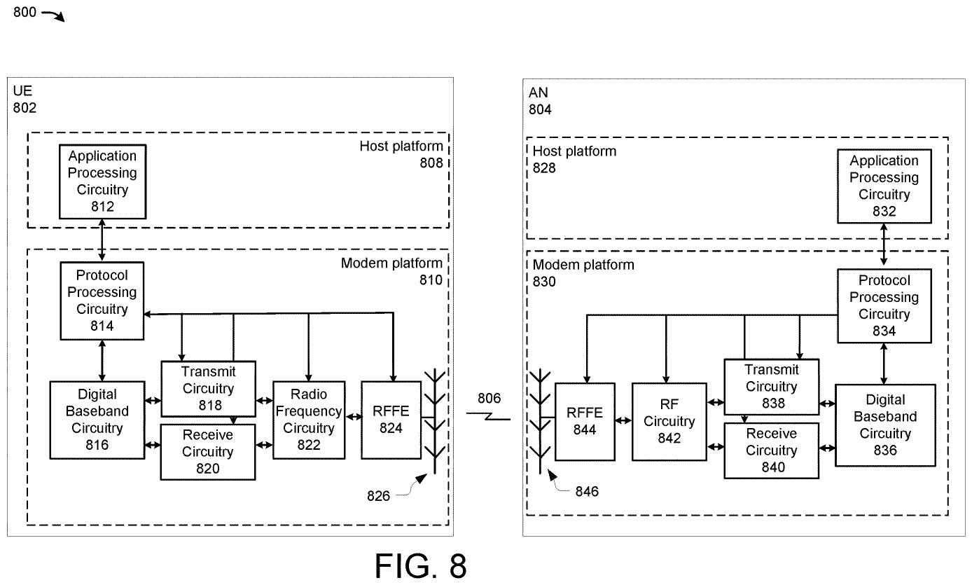

FIG. 8 schematically illustrates a wireless network 800 in accordance with various embodiments. The wireless network 800 may include a UE 802 in wireless communication with an AN 804. The UE 802 and AN 804 may be similar to, and substantially interchangeable with, like-named components described elsewhere herein.

The UE 802 may be communicatively coupled with the AN 804 via connection 806. The connection 806 is illustrated as an air interface to enable communicative coupling, and can be consistent with cellular communications protocols such as an LTE protocol or a 5G NR protocol operating at mmWave or sub-6 GHz frequencies.

The UE 802 may include a host platform 808 coupled with a modem platform 810. The host platform 808 may include application processing circuitry 812, which may be coupled with protocol processing circuitry 814 of the modem platform 810. The application processing circuitry 812 may run various applications for the UE 802 that source/sink application data. The application processing circuitry 812 may further implement one or more layer operations to transmit/receive application data to/from a data network. These layer operations may include transport (for example UDP) and Internet (for example, IP) operations

The protocol processing circuitry 814 may implement one or more of layer operations to facilitate transmission or reception of data over the connection 806. The layer operations implemented by the protocol processing circuitry 814 may include, for example, MAC, RLC, PDCP, RRC and NAS operations.

The modem platform 810 may further include digital baseband circuitry 816 that may implement one or more layer operations that are “below” layer operations performed by the protocol processing circuitry 814 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 810 may further include transmit circuitry 818, receive circuitry 820, RF circuitry 822, and RF front end (RFFE) 824, which may include or connect to one or more antenna panels 826. Briefly, the transmit circuitry 818 may include a digital-to-analog converter, mixer, intermediate frequency (IF) components, etc.; the receive circuitry 820 may include an analog-to-digital converter, mixer, IF components, etc.; the RF circuitry 822 may include a low-noise amplifier, a power amplifier, power tracking components, etc.; RFFE 824 may include filters (for example, surface/bulk acoustic wave filters), switches, antenna tuners, beamforming components (for example, phase-array antenna components), etc. The selection and arrangement of the components of the transmit circuitry 818, receive circuitry 820, RF circuitry 822, RFFE 824, and antenna panels 826 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 814 may include one or more instances of control circuitry (not shown) to provide control functions for the transmit/receive components.

A UE reception may be established by and via the antenna panels 826, RFFE 824, RF circuitry 822, receive circuitry 820, digital baseband circuitry 816, and protocol processing circuitry 814. In some embodiments, the antenna panels 826 may receive a transmission from the AN 804 by receive-beamforming signals received by a plurality of antennas/antenna elements of the one or more antenna panels 826.

A UE transmission may be established by and via the protocol processing circuitry 814, digital baseband circuitry 816, transmit circuitry 818, RF circuitry 822, RFFE 824, and antenna panels 826. In some embodiments, the transmit components of the UE 804 may apply a spatial filter to the data to be transmitted to form a transmit beam emitted by the antenna elements of the antenna panels 826.

Similar to the UE 802, the AN 804 may include a host platform 828 coupled with a modem platform 830. The host platform 828 may include application processing circuitry 832 coupled with protocol processing circuitry 834 of the modem platform 830. The modem platform may further include digital baseband circuitry 836, transmit circuitry 838, receive circuitry 840, RF circuitry 842, RFFE circuitry 844, and antenna panels 846. The components of the AN 804 may be similar to and substantially interchangeable with like-named components of the UE 802. In addition to performing data transmission/reception as described above, the components of the AN 808 may perform various logical functions that include, for example, RNC functions such as radio bearer management, uplink and downlink dynamic radio resource management, and data packet scheduling.

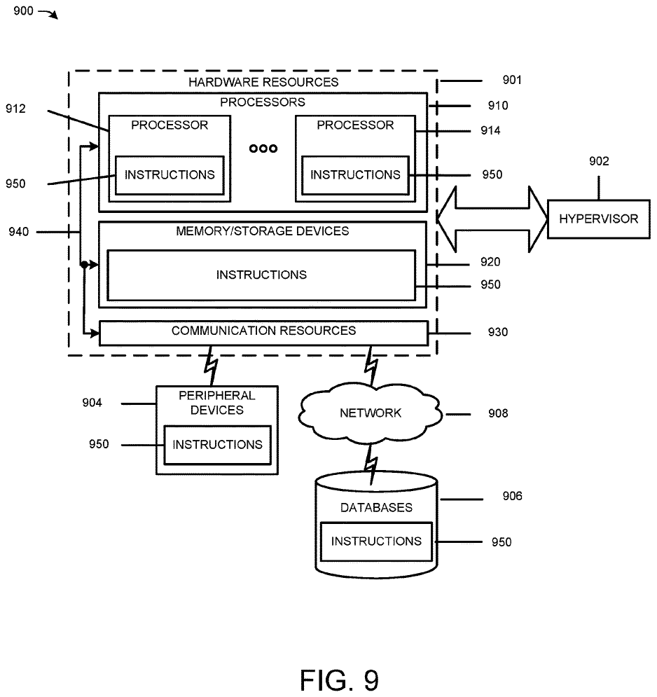

FIG. 9 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 9 shows a diagrammatic representation of hardware resources 900 including one or more processors (or processor cores) 910, one or more memory/storage devices 920, and one or more communication resources 930, each of which may be communicatively coupled via a bus 940 or other interface circuitry. For embodiments where node virtualization (e.g., NFV) is utilized, a hypervisor 902 may be executed to provide an execution environment for one or more network slices/sub-slices to utilize the hardware resources 900.

The processors 910 may include, for example, a processor 912 and a processor 914. The processors 910 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 920 may include main memory, disk storage, or any suitable combination thereof. The memory/storage devices 920 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 930 may include interconnection or network interface controllers, components, or other suitable devices to communicate with one or more peripheral devices 904 or one or more databases 906 or other network elements via a network 908. For example, the communication resources 930 may include wired communication components (e.g., for coupling via USB, Ethernet, etc.), cellular communication components, NFC components, Bluetooth® (or Bluetooth® Low Energy) components, Wi-Fi® components, and other communication components.

Instructions 950 may comprise software, a program, an application, an applet, an app, or other executable code for causing at least any of the processors 910 to perform any one or more of the methodologies discussed herein. The instructions 950 may reside, completely or partially, within at least one of the processors 910 (e.g., within the processor's cache memory), the memory/storage devices 920, or any suitable combination thereof. Furthermore, any portion of the instructions 950 may be transferred to the hardware resources 900 from any combination of the peripheral devices 904 or the databases 906. Accordingly, the memory of processors 610, the memory/storage devices 920, the peripheral devices 904, and the databases 906 are examples of computer-readable and machine-readable media.

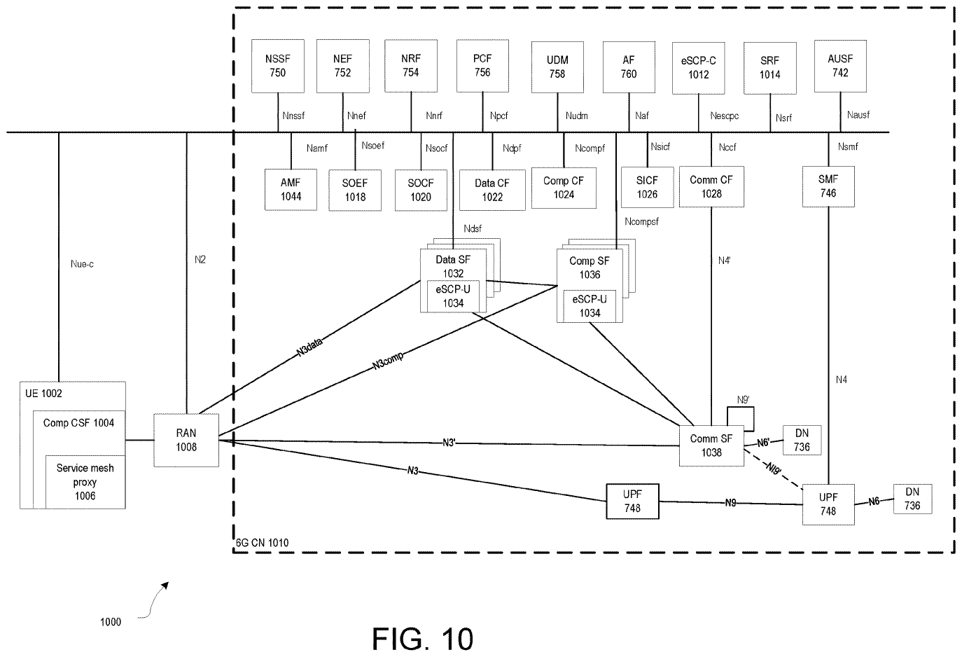

FIG. 10 illustrates a network, in accordance with one or more example embodiments of the present disclosure.

The network 1000 may operate in a matter consistent with 3GPP technical specifications or technical reports for 6G systems. In some examples, the network 1000 may operate concurrently with network 700. For example, in some examples, the network 1000 may share one or more frequency or bandwidth resources with network 700. As one specific example, a UE (e.g., UE 1002) may be configured to operate in both network 1000 and network 700. Such configuration may be based on a UE including circuitry configured for communication with frequency and bandwidth resources of both networks 1000 and 700. In general, several elements of network 1000 may share one or more characteristics with elements of network 700. For the sake of brevity and clarity, such elements may not be repeated in the description of network 1000.

The network 1000 may include a UE 1002, which may include any mobile or non-mobile computing device designed to communicate with a RAN 1008 via an over-the-air connection. The UE 1002 may be similar to, for example, UE 702. The UE 1002 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 10, in some examples the network 1000 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 10, the UE 1002 may be communicatively coupled with an AP such as AP 706 as described with respect to FIG. 7. Additionally, although not specifically shown in FIG. 10, in some examples the RAN 1008 may include one or more ANs such as AN 708 as described with respect to FIG. 10. The RAN 1008 and/or the AN of the RAN 1008 may be referred to as a base station (BS), a RAN node, or using some other term or name.

The UE 1002 and the RAN 1008 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 1008 may allow for communication between the UE 1002 and a 6G core network (CN) 1010. Specifically, the RAN 1008 may facilitate the transmission and reception of data between the UE 1002 and the 6G CN 1010. The 6G CN 1010 may include various functions such as NSSF 750, NEF 752, NRF 754, PCF 756, UDM 758, AF 760, SMF 746, and AUSF 742. The 6G CN 1010 may additional include UPF 748 and DN 736 as shown in FIG. 10.

Additionally, the RAN 1008 may include various additional functions that are in addition to, or alternative to, functions of a legacy cellular network such as a 4G or 5G network. Two such functions may include a Compute Control Function (Comp CF) 1024 and a Compute Service Function (Comp SF) 1036. The Comp CF 1024 and the Comp SF 1036 may be parts or functions of the Computing Service Plane. Comp CF 1024 may be a control plane function that provides functionalities such as management of the Comp SF 1036, computing task context generation and management (e.g., create, read, modify, delete), interaction with the underlaying computing infrastructure for computing resource management, etc. Comp SF 1036 may be a user plane function that serves as the gateway to interface computing service users (such as UE 1002) and computing nodes behind a Comp SF instance. Some functionalities of the Comp SF 1036 may include: parse computing service data received from users to compute tasks executable by computing nodes; hold service mesh ingress gateway or service API gateway; service and charging policies enforcement; performance monitoring and telemetry collection, etc. In some examples, a Comp SF 1036 instance may serve as the user plane gateway for a cluster of computing nodes. A Comp CF 1024 instance may control one or more Comp SF 1036 instances.

Two other such functions may include a Communication Control Function (Comm CF) 1028 and a Communication Service Function (Comm SF) 1038, which may be parts of the Communication Service Plane. The Comm CF 1028 may be the control plane function for managing the Comm SF 1038, communication sessions creation/configuration/releasing, and managing communication session context. The Comm SF 1038 may be a user plane function for data transport. Comm CF 1028 and Comm SF 1038 may be considered as upgrades of SMF 746 and UPF 748, which were described with respect to a 5G system in FIG. 7. The upgrades provided by the Comm CF 1028 and the Comm SF 1038 may enable service-aware transport. For legacy (e.g., 4G or 5G) data transport, SMF 746 and UPF 748 may still be used.

Two other such functions may include a Data Control Function (Data CF) 1022 and Data Service Function (Data SF) 1032 may be parts of the Data Service Plane. Data CF 1022 may be a control plane function and provides functionalities such as Data SF 1032 management, Data service creation/configuration/releasing, Data service context management, etc. Data SF 1032 may be a user plane function and serve as the gateway between data service users (such as UE 1002 and the various functions of the 6G CN 1010) and data service endpoints behind the gateway. Specific functionalities may include: parse data service user data and forward to corresponding data service endpoints, generate charging data, report data service status.

Another such function may be the Service Orchestration and Chaining Function (SOCF) 1020, which may discover, orchestrate and chain up communication/computing/data services provided by functions in the network. Upon receiving service requests from users, SOCF 1020 may interact with one or more of Comp CF 1024, Comm CF 1028, and Data CF 1022 to identify Comp SF 1036, Comm SF 1038, and Data SF 1032 instances, configure service resources, and generate the service chain, which could contain multiple Comp SF 1036, Comm SF 1038, and Data SF 1032 instances and their associated computing endpoints. Workload processing and data movement may then be conducted within the generated service chain. The SOCF 1020 may also responsible for maintaining, updating, and releasing a created service chain.

Another such function may be the service registration function (SRF) 1014, which may act as a registry for system services provided in the user plane such as services provided by service endpoints behind Comp SF 1036 and Data SF 1032 gateways and services provided by the UE 1002. The SRF 1014 may be considered a counterpart of NRF 754, which may act as the registry for network functions.

Other such functions may include an evolved service communication proxy (eSCP) and service infrastructure control function (SICF) 1026, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 1012 and eSCP-U 1034, for control plane service communication proxy and user plane service communication proxy, respectively. The SICF 1026 may control and configure eCSP instances in terms of service traffic routing policies, access rules, load balancing configurations, performance monitoring, etc.

Another such function is the AMF 1044. The AMF 1044 may be similar to 744, but with additional functionality. Specifically, the AMF 1044 may include potential functional repartition, such as move the message forwarding functionality from the AMF 1044 to the RAN 1008.

Another such function is the service orchestration exposure function (SOEF) 1018. The SOEF may be configured to expose service orchestration and chaining services to external users such as applications.

The UE 1002 may include an additional function that is referred to as a computing client service function (comp CSF) 1004. The comp CSF 1004 may have both the control plane functionalities and user plane functionalities, and may interact with corresponding network side functions such as SOCF 1020, Comp CF 1024, Comp SF 1036, Data CF 1022, and/or Data SF 1032 for service discovery, request/response, compute task workload exchange, etc. The Comp CSF 1004 may also work with network side functions to decide on whether a computing task should be run on the UE 1002, the RAN 1008, and/or an element of the 6G CN 1010.

The UE 1002 and/or the Comp CSF 1004 may include a service mesh proxy 1006. The service mesh proxy 1006 may act as a proxy for service-to-service communication in the user plane. Capabilities of the service mesh proxy 1006 may include one or more of addressing, security, load balancing, and/or the like.

FIG. 11 illustrates a simplified block diagram of artificial (AI)-assisted communication between a user equipment and a radio access network, in accordance with one or more example embodiments of the present disclosure.

FIG. 11 depicts an example artificial (AI)-assisted communication architecture. More specifically, as described in further detail below, AI/machine learning (ML) models may be used or leveraged to facilitate over-the-air communication between UE 1105 and RAN 1110.

In this example, the UE 1105 and the RAN 1110 operate in a matter consistent with 3GPP technical specifications and/or technical reports for 6G systems. In some examples, the wireless cellular communication between the UE 1105 and the RAN 1110 may be part of, or operate concurrently with, networks 700, 1000, and/or some other network described herein.

The UE 1105 may be similar to, and share one or more features with, UE 702, UE 1002, and/or some other UE described herein. The UE 1105 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc. The RAN 1110 may be similar to, and share one or more features with, RAN 714, RAN 1008, and/or some other RAN described herein.

As may be seen in FIG. 11, the AI-related elements of UE 1105 may be similar to the AI-related elements of RAN 1110. For the sake of discussion herein, description of the various elements will be provided from the point of view of the UE 1105, however it will be understood that such discussion or description will apply to equally named/numbered elements of RAN 1110, unless explicitly stated otherwise.

As previously noted, the UE 1105 may include various elements or functions that are related to AI/ML. Such elements may be implemented as hardware, software, firmware, and/or some combination thereof. In examples, one or more of the elements may be implemented as part of the same hardware (e.g., chip or multi-processor chip), software (e.g., a computing program), or firmware as another element.

One such element may be a data repository 1115. The data repository 1115 may be responsible for data collection and storage. Specifically, the data repository 1115 may collect and store RAN configuration parameters, measurement data, performance key performance indicators (KPIs), model performance metrics, etc., for model training, update, and inference. More generally, collected data is stored into the repository. Stored data can be discovered and extracted by other elements from the data repository 1115. For example, as may be seen, the inference data selection/filter element 1150 may retrieve data from the data repository 1115. In various examples, the UE 1105 may be configured to discover and request data from the data repository 1115 in the RAN, and vice versa. More generally, the data repository 1115 of the UE 805 may be communicatively coupled with the data repository 1115 of the RAN 1110 such that the respective data repositories of the UE and the RAN may share collected data with one another.

Another such element may be a training data selection/filtering functional block 1120. The training data selection/filter functional block 1120 may be configured to generate training, validation, and testing datasets for model training. Training data may be extracted from the data repository 1115. Data may be selected/filtered based on the specific AI/ML model to be trained. Data may optionally be transformed/augmented/pre-processed (e.g., normalized) before being loaded into datasets. The training data selection/filter functional block 1120 may label data in datasets for supervised learning. The produced datasets may then be fed into model training the model training functional block 1125.

As noted above, another such element may be the model training functional block 1125. This functional block may be responsible for training and updating (re-training) AI/ML models. The selected model may be trained using the fed-in datasets (including training, validation, testing) from the training data selection/filtering functional block. The model training functional block 1125 may produce trained and tested AI/ML models which are ready for deployment. The produced trained and tested models can be stored in a model repository 1135.

The model repository 1135 may be responsible for AI/ML models' (both trained and un-trained) storage and exposure. Trained/updated model(s) may be stored into the model repository 1135. Model and model parameters may be discovered and requested by other functional blocks (e.g., the training data selection/filter functional block 1120 and/or the model training functional block 1125). In some examples, the UE 1105 may discover and request AI/ML models from the model repository 1135 of the RAN 1110. Similarly, the RAN 1110 may be able to discover and/or request AI/ML models from the model repository 1135 of the UE 1105. In some examples, the RAN 1110 may configure models and/or model parameters in the model repository 1135 of the UE 1105.

Another such element may be a model management functional block 1140. The model management functional block 1140 may be responsible for management of the AI/ML model produced by the model training functional block 1125. Such management functions may include deployment of a trained model, monitoring model performance, etc. In model deployment, the model management functional block 1140 may allocate and schedule hardware and/or software resources for inference, based on received trained and tested models. As used herein, “inference” refers to the process of using trained AI/ML model(s) to generate data analytics, actions, policies, etc. based on input inference data. In performance monitoring, based on wireless performance KPIs and model performance metrics, the model management functional block 1140 may decide to terminate the running model, start model re-training, select another model, etc. In examples, the model management functional block 1140 of the RAN 1110 may be able to configure model management policies in the UE 1105 as shown.

Another such element may be an inference data selection/filtering functional block 1150. The inference data selection/filter functional block 1150 may be responsible for generating datasets for model inference at the inference functional block 1145, as described below. Specifically, inference data may be extracted from the data repository 1115. The inference data selection/filter functional block 1150 may select and/or filter the data based on the deployed AI/ML model. Data may be transformed/augmented/pre-processed following the same transformation/augmentation/pre-processing as those in training data selection/filtering as described with respect to functional block 1120. The produced inference dataset may be fed into the inference functional block 1145.

Another such element may be the inference functional block 1145. The inference functional block 1145 may be responsible for executing inference as described above. Specifically, the inference functional block 1145 may consume the inference dataset provided by the inference data selection/filtering functional block 1150, and generate one or more outcomes. Such outcomes may be or include data analytics, actions, policies, etc. The outcome(s) may be provided to the performance measurement functional block 1130.

The performance measurement functional block 1130 may be configured to measure model performance metrics (e.g., accuracy, model bias, run-time latency, etc.) of deployed and executing models based on the inference outcome(s) for monitoring purpose. Model performance data may be stored in the data repository 1115.

The following examples pertain to further embodiments.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Various embodiments are described below.

Example 1 may include a user equipment (UE) device for receiving network-assisted multi-user multiple input multiple output (MU-MIMO) signaling, the UE device comprising processing circuitry coupled to storage for storing information associated with the MU-MIMO signaling, the processing circuitry configured to: decode a MU-MIMO set-up field in a radio resource control (RRC) message sent from a Next Generation NodeB (gNB); determine, based on at least two bits in the MU-MIMO set-up field, that a MU-MIMO transmission is enabled; and determine, based on that least two bits, a modulation scheme for co-scheduled UE devices.

Example 2 may include the UE device of example 1 and/or any other example herein, wherein the processing circuitry is further configured to, in response to determining that the MU-MIMO transmission is enabled: configure first parameters on a demodulation reference signal and a physical downlink shared control channel (PDSCH) allocation, using second parameters of a second UE device, based on signaling by at least one of downlink control information (DCI) or the RRC message.

Example 3 may include the UE device of example 2 and/or any other example herein, wherein the first parameters comprise a demodulation reference signal configuration, a scrambling identifier setting rule, and a precoding granularity.

Example 4 may include the UE device of example 2 and/or any other example herein, wherein the first parameters comprise a same allocation region in at least one of time or frequency resources as the second UE device.

Example 5 may include the UE device of example 1 and/or any other example herein, wherein the processing circuitry is further configured to: decode port presence information and modulation orders of an interfering layer signaled in DCI fields.

Example 6 may include the UE device of example 5 and/or any other example herein, wherein the DCI fields use a form of variable size depending on a maximum number of MIMO layers of a bandwidth part.

Example 7 may include the UE device of example 5 and/or any other example herein, wherein the DCI fields comprise a field jointly representing interference presence, modulation order, and port location by cyclic ordering.

Example 8 may include the UE device of example 5 and/or any other example herein, wherein the DCI fields correspond to two or more antennae ports of the UE device.

Example 9 may include the UE device of example 1 and/or any other example herein, wherein the processing circuitry is further configured to: detect a MU-MIMO scheduler flexibility defining a scheduler restriction as a maximum number of allowed resource allocation transitions per interfering layer.

Example 10 may include a computer-readable storage medium comprising instructions to cause processing circuitry of a user equipment (UE) device for receiving network-assisted multi-user multiple input multiple output (MU-MIMO) signaling, upon execution of the instructions by the processing circuitry, to: decode a MU-MIMO set-up field in a radio resource control (RRC) message sent from a Next Generation NodeB (gNB); determine, based on at least two bits in the MU-MIMO set-up field, that a MU-MIMO transmission is enabled; and determine, based on that least two bits, a modulation scheme for co-scheduled UE devices.

Example 11 may include the computer-readable storage medium of example 10 and/or any other example herein, wherein execution of the instructions further causes the processing circuitry to, in response to determining that the MU-MIMO transmission is enabled: configure first parameters on a demodulation reference signal and a physical downlink shared control channel (PDSCH) allocation, using second parameters of a second UE device, based on signaling by at least one of downlink control information (DCI) or the RRC message.

Example 12 may include the computer-readable storage medium of example 11 and/or any other example herein, wherein the first parameters comprise a demodulation reference signal configuration, a scrambling identifier setting rule, and a precoding granularity.

Example 13 may include the computer-readable storage medium of example 11 and/or any other example herein, wherein the first parameters comprise a same allocation region in at least one of time or frequency resources as the second UE device.

Example 14 may include the computer-readable storage medium of example 10, wherein execution of the instructions further causes the processing circuitry to: decode port presence information and modulation orders of an interfering layer signaled in DCI fields.

Example 15 may include the computer-readable storage medium of example 14 and/or any other example herein, wherein the DCI fields use a form of variable size depending on a maximum number of MIMO layers of a bandwidth part.

Example 16 may include the computer-readable storage medium of example 14 and/or any other example herein, wherein the DCI fields comprise a field jointly representing interference presence, modulation order, and port location by cyclic ordering.

Example 17 may include the computer-readable storage medium of example 14 and/or any other example herein, wherein the DCI fields correspond to two or more antennae ports of the UE device.

Example 18 may include a method for receiving network-assisted multi-user multiple input multiple output (MU-MIMO) signaling, the method comprising: decoding, by processing circuitry of a user equipment (UE) device, a MU-MIMO set-up field in a radio resource control (RRC) message sent from a Next Generation NodeB (gNB); determining, by the processing circuitry, based on at least two bits in the MU-MIMO set-up field, that a MU-MIMO transmission is enabled; and determining, by the processing circuitry, based on that least two bits, a modulation scheme for co-scheduled UE devices.

Example 19 may include a computer-readable storage medium comprising instructions to perform the method of example 18.

Example 20 may include an apparatus comprising means for performing the method of example 18.

Example 21 may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Example 22 may include an apparatus comprising logic, modules, and/or circuitry to perform one or more elements of a method described in or related to any of examples 1-21, or any other method or process described herein.

Example 23 may include a method, technique, or process as described in or related to any of examples 1-21, or portions or parts thereof.

Example 24 may include an apparatus comprising: one or more processors and one or more computer readable media comprising instructions that, when executed by the one or more processors, cause the one or more processors to perform the method, techniques, or process as described in or related to any of examples 1-21, or portions thereof.

Example 25 may include a method of communicating in a wireless network as shown and described herein.

Example 26 may include a system for providing wireless communication as shown and described herein.

Example 27 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

Unless used differently herein, terms, definitions, and abbreviations may be consistent with terms, definitions, and abbreviations defined in 3GPP TR 21.905 v16.0.0 (June 2019) and/or any other 3GPP standard. For the purposes of the present document, the following abbreviations (shown in Table 5) may apply to the examples and embodiments discussed herein.

TABLE 5
Abbreviations

| | | |
|---|---|---|
| 3GPP Third Generation | IBE In-Band Emission | PUSCH Physical Uplink Shared |
| Partnership Project | | Channel |
| 4G Fourth Generation | IEEE Institute of Electrical | QAM Quadrature Amplitude |
| | and Electronics | Modulation |
| | Engineers | |
| 5G Fifth Generation | IEI Information Element | QCI QoS class of identifier |
| | Identifier | |
| 5GC 5G Core network | IEIDL Information Element | QCL Quasi co-location |
| | Identifier Data Length | |
| AC Application Client | IETF Internet Engineering | QFI QoS Flow ID, QoS |
| | Task Force | Flow Identifier |
| ACK Acknowledgement | IF Infrastructure | QoS Quality of Service |
| ACID Application Client | IM Interference | QPSK Quadrature |
| Identification | Measurement, | (Quaternary) Phase |
| | Intermodulation, IP | Shift Keying |
| | Multimedia | |
| AF Application Function | IMC IMS Credentials | QZSS Quasi-Zenith Satellite |
| | | System |
| AM Acknowledged Mode | IMEI International Mobile | RA-RNTI Random Access RNTI |
| | Equipment Identity | |
| AMBR Aggregate Maximum Bit | IMGI International mobile | RAB Radio Access Bearer, |
| Rate | group identity | Random Access Burst |
| AMF Access and Mobility | IMPI IP Multimedia Private | RACH Random Access |
| Management Function | Identity | Channel |
| AN Access Network | IMPU IP Multimedia PUblic | RADIUS Remote Authentication |
| | identity | Dial In User Service |
| ANR Automatic Neighbour | IMS IP Multimedia | RAN Radio Access Network |
| Relation | Subsystem | |
| AP Application Protocol, | IMSI International Mobile | RAND RANDom number |
| Antenna Port, Access | Subscriber Identity | (used for |
| Point | | authentication) |
| API Application Programming | IoT Internet of Things | RAR Random Access Response |
| Interface | | |
| APN Access Point Name | IP Internet Protocol | RAT Radio Access |
| | | Technology |
| ARP Allocation and Retention | Ipsec IP Security, Internet | RAU Routing Area Update |
| Priority | Protocol Security | |
| ARQ Automatic Repeat Request | IP-CAN IP-Connectivity | RB Resource block, Radio |
| | Access Network | Bearer |
| AS Access Stratum | IP-M IP Multicast | RBG Resource block group |
| ASP Application Service | IPv4 Internet Protocol | REG Resource Element |
| Provider | Version 4 | Group |
| ASN.1 Abstract Syntax Notation | IPv6 Internet Protocol | Rel Release |
| One | Version 6 | |
| AUSF Authentication Server | IR Infrared | REQ REQuest |
| Function | | |
| AWGN Additive White Gaussian | IS In Sync | RF Radio Frequency |
| Noise | | |
| BAP Backhaul Adaptation | IRP Integration Reference | RI Rank Indicator |
| Protocol | Point | |
| BCH Broadcast Channel | ISDN Integrated Services | RIV Resource indicator |
| | Digital Network | value |
| BER Bit Error Ratio | ISIM IM Services Identity | RL Radio Link |
| | Module | |
| BFD Beam Failure Detection | ISO International | RLC Radio Link Control, |
| | Organisation for | Radio Link Control |
| | Standardisation | layer |
| BLER Block Error Rate | ISP Internet Service | RLC AM RLC Acknowledged |
| | Provider | Mode |
| BPSK Binary Phase Shift Keying | IWF Interworking-Function | RLC UM RLC Unacknowledged |
| | | Mode |
| BRAS Broadband Remote | I-WLAN Interworking WLAN | RLF Radio Link Failure |
| Access Server | | |
| BSS Business Support System | Constraint length of the | RLM Radio Link Monitoring |
| | convolutional code, USIM | |
| | Individual key | |
| BS Base Station | kB Kilobyte (1000 bytes) | RLM-RS Reference Signal for |
| | | RLM |
| BSR Buffer Status Report | kbps kilo-bits per second | RM Registration |
| | | Management |
| BW Bandwidth | Kc Ciphering key | RMC Reference |
| | | Measurement Channel |
| BWP Bandwidth Part | Ki Individual subscriber | RMSI Remaining MSI, |
| | authentication key | Remaining Minimum |
| | | System Information |
| C-RNTI Cell Radio Network | KPI Key Performance | RN Relay Node |
| Temporary Identity | Indicator | |
| CA Carrier Aggregation, | KQI Key Quality Indicator | RNC Radio Network |
| Certification Authority | | Controller |
| CAPEX CAPital EXpenditure | KSI Key Set Identifier | RNL Radio Network Layer |
| CBRA Contention Based Random | ksps kilo-symbols per | RNTI Radio Network |
| Access | second | Temporary Identifier |
| CC Component Carrier, | KVM Kernel Virtual | ROHC RObust Header |
| Country Code, | Machine | Compression |
| Cryptographic Checksum | | |
| CCA Clear Channel Assessment | L1 Layer 1 (physical | RRC Radio Resource |
| | layer) | Control, Radio |
| | | Resource Control layer |
| CCE Control Channel Element | L1-RSRP Layer 1 reference | RRM Radio Resource |
| | signal received power | Management |
| CCCH Common Control Channel | L2 Layer 2 (data link | RS Reference Signal |
| | layer) | |
| CE Coverage Enhancement | L3 Layer 3 (network | RSRP Reference Signal |
| | layer) | Received Power |
| CDM Content Delivery Network | LAA Licensed Assisted | RSRQ Reference Signal |
| | Access | Received Quality |
| CDMA Code-Division Multiple | LAN Local Area Network | RSSI Received Signal |
| Access | | Strength Indicator |
| CFRA Contention Free Random | LADN Local Area Data | RSU Road Side Unit |
| Access | Network | |
| CG Cell Group | LBT Listen Before Talk | RSTD Reference Signal Time |
| | | difference |
| CGF Charging Gateway | LCM LifeCycle | RTP Real Time Protocol |
| Function | Management | |
| CHF Charging Function | LCR Low Chip Rate | RTS Ready-To-Send |
| CI Cell Identity | LCS Location Services | RTT Round Trip Time |
| CID Cell-ID (e.g., positioning | LCID Logical Channel ID | Rx Reception, Receiving, |
| method) | | Receiver |
| CIM Common Information | LI Layer Indicator | S1AP S1 Application |
| Model | | Protocol |
| CIR Carrier to Interference | LLC Logical Link Control, | S1-MMES1 for the control plane |
| Ratio | Low Layer | |
| | Compatibility | |
| CK Cipher Key | LPLMN Local PLMN | S1-U S1 for the user plane |
| CM Connection Management, | LPP LTE Positioning | S-GW Serving Gateway |
| Conditional Mandatory | Protocol | |
| CMAS Commercial Mobile Alert | LSB Least Significant Bit | S-RNTI SRNC Radio Network |
| Service | | Temporary Identity |
| CMD Command | LTE Long Term Evolution | S-TMSI SAE Temporary |
| | | Mobile Station |
| | | Identifier |
| CMS Cloud Management | LWA LTE-WLAN | SA Standalone operation |
| System | aggregation | mode |
| CO Conditional Optional | LWIP LTE/WLAN Radio | SAE System Architecture |
| | Level Integration with | Evolution |
| | IPsec Tunnel | |
| COMP Coordinated Multi-Point | LTE Long Term Evolution | SAP Service Access Point |
| CORESET Control Resource Set | M2M Machine-to-Machine | SAPD Service Access Point |
| | | Descriptor |
| COTS Commercial Off-The- | MAC Medium Access | SAPI Service Access Point |
| Shelf | Control (protocol | Identifier |
| | layering context) | |
| CP Control Plane, Cyclic | MAC Message authentication | SCC |
| Prefix, Connection Point | code (security/encryption | Secondary Component |
| | context) | Carrier, Secondary CC |
| CPD Connection Point | MAC-A MAC used for | SCell Secondary Cell |
| Descriptor | authentication and key | |
| | agreement (TSG T | |
| | WG3 context) | |
| CPE Customer Premise | MAC-I MAC used for data | SCEF Service Capability |
| Equipment | integrity of signalling | Exposure Function |
| | messages (TSG T | |
| | WG3 context) | |
| CPICH Common Pilot Channel | MANO Management and | SC-FDMA Single Carrier |
| | Orchestration | Frequency Division |
| | | Multiple Access |
| CQI Channel Quality Indicator | MBMS Multimedia Broadcast | SCG Secondary Cell Group |
| | and Multicast Service | |
| CPU CSI processing unit, | MBSFN Multimedia Broadcast | SCM Security Context |
| Central Processing Unit | multicast service | Management |
| | Single Frequency | |
| | Network | |
| C/R Command/Response field | MCC Mobile Country Code | SCS Subcarrier Spacing |
| bit | | |
| CRAN Cloud Radio Access | MCG Master Cell Group | SCTP Stream Control |
| Network, Cloud RAN | | Transmission Protocol |
| CRB Common Resource Block | MCOT Maximum Channel | SDAP Service Data |
| | Occupancy Time | Adaptation Protocol, |
| | | Service Data |
| | | Adaptation Protocol |
| | | layer |
| CRC Cyclic Redundancy Check | MCS Modulation and coding | SDL Supplementary |
| | scheme | Downlink |
| CRI Channel-State Information | MDAF Management Data | SDNF Structured Data |
| Resource Indicator, CSI- | Analytics Function | Storage Network |
| RS Resource Indicator | | Function |
| C-RNTI Cell RNTI | MDAS Management Data | SDP Session Description |
| | Analytics Service | Protocol |
| CS Circuit Switched | MDT Minimization of Drive | SDSF Structured Data |
| | Tests | Storage Function |
| CSAR Cloud Service Archive | ME Mobile Equipment | SDU Service Data Unit |
| CSI Channel-State Information | MeNB master eNB | SEAF Security Anchor |
| | | Function |
| CSI-IM CSI Interference | MER Message Error Ratio | SeNB secondary eNB |
| Measurement | | |
| CSI-RS CSI Reference Signal | MGL Measurement Gap | SEPP Security Edge |
| | Length | Protection Proxy |
| CSI-RSRP CSI reference signal | MGRP Measurement Gap | SFI Slot format indication |
| received power | Repetition Period | |
| CSI-RSRQ CSI reference signal | MIB Master Information | SFTD Space-Frequency Time |
| received quality | Block, Management | Diversity, SFN and |
| | Information Base | frame timing difference |
| CSI-SINR CSI signal-to-noise and | MIMO Multiple Input | SFN System Frame Number |
| interference ratio | Multiple Output | |
| CSMA Carrier Sense Multiple | MLC Mobile Location | SgNB Secondary gNB |
| Access | Centre | |
| CSMA/CA CSMA with collision | MM Mobility Management | SGSN Serving GPRS Support |
| avoidance | | Node |
| CSS Common Search Space, | MME Mobility Management | S-GW Serving Gateway |
| Cell-specific Search Space | Entity | |
| CTF Charging Trigger Function | MN Master Node | SI System Information |
| CTS Clear-to-Send | MNO Mobile Network | SI-RNTI System Information |
| | Operator | RNTI |
| CW Codeword | MO Measurement Object, | SIB System Information |
| | Mobile Originated | Block |
| CWS Contention Window Size | MPBCH MTC Physical | SIM Subscriber Identity |
| | Broadcast CHannel | Module |
| D2D Device-to-Device | MPDCCH MTC Physical | SIF Session Initiated |
| | Downlink Control | Protocol |
| | CHannel | |
| DC Dual Connectivity, Direct | MPDSCH MTC Physical | SIP System in Package |
| Current | Downlink Shared | |
| | CHannel | |
| DCI Downlink Control | MPRACH MTC Physical | SL Sidelink |
| Information | Random Access | |
| | CHannel | |
| DF Deployment Flavour | MPUSCH MTC Physical Uplink | SLA Service Level |
| | Shared Channel | Agreement |
| DL Downlink | MPLS MultiProtocol Label | SM Session Management |
| | Switching | |
| DMTF Distributed Management | MS Mobile Station | SMF Session Management |
| Task Force | | Function |
| DPDK Data Plane Development | MSB Most Significant Bit | SMS Short Message Service |
| Kit | | |
| DM-RS, DMRS Demodulation | MSC Mobile Switching | SMSF SMS Function |
| Reference Signal | Centre | |
| DN Data network | MSI Minimum System | SMTC SSB-based |
| | Information, MCH | Measurement Timing |
| | Scheduling | Configuration |
| | Information | |
| DNN Data Network Name | MSID Mobile Station | SN Secondary Node, |
| | Identifier | Sequence Number |
| DNAI Data Network Access | MSIN Mobile Station | SoC System on Chip |
| Identifier | Identification Number | |
| DRB Data Radio Bearer | MSISDN Mobile Subscriber | SON Self-Organizing |
| | ISDN Number | Network |
| DRS Discovery Reference | MT Mobile Terminated, | SpCell Special Cell |
| Signal | Mobile Termination | |
| DRX Discontinuous Reception | MTC Machine-Type | SP-CSI-RNTI Semi-Persistent |
| | Communications | CSI RNTI |
| DSL Domain Specific | mMTC massive MTC, massive | SPS Semi-Persistent |
| Language. Digital | Machine-Type | Scheduling |
| Subscriber Line | Communications | |
| DSLAM DSL Access Multiplexer | MU-MIMO Multi User MIMO | SQN Sequence number |
| DwPTS Downlink Pilot Time Slot | MWUS MTC wake-up signal, | SR Scheduling Request |
| | MTC WUS | |
| E-LAN Ethernet Local Area | NACK Negative | SRB Signalling Radio |
| Network | Acknowledgement | Bearer |
| E2E End-to-End | NAI Network Access | SRS Sounding Reference |
| | Identifier | Signal |
| ECCA extended clear channel | NAS Non-Access Stratum, | SS Synchronization Signal |
| assessment, extended | Non-Access Stratum | |
| CCA | layer | |
| ECCE Enhanced Control | NCT Network Connectivity | SSB Synchronization Signal |
| Channel Element, | Topology | Block |
| Enhanced CCE | | |
| ED Energy Detection | NC-JT Non-Coherent Joint | SSID Service Set Identifier |
| | Transmission | |
| EDGE Enhanced Datarates for | NEC Network Capability | SS/PBCH Block |
| GSM Evolution (GSM | Exposure | |
| Evolution) | | |
| EAS Edge Application Server | NE-DC NR-E-UTRA Dual | SSBRI SS/PBCH Block |
| | Connectivity | Resource Indicator, |
| | | Synchronization Signal |
| | | Block Resource |
| | | Indicator |
| EASID Edge Application Server | NEF Network Exposure | SSC Session and Service |
| Identification | Function | Continuity |
| ECS Edge Configuration Server | NF Network Function | SS-RSRP Synchronization Signal |
| | | based Reference Signal |
| | | Received Power |
| ECSP Edge Computing Service | NFP Network Forwarding | SS-RSRQ Synchronization Signal |
| Provider | Path | based Reference Signal |
| | | Received Quality |
| EDN Edge Data Network | NFPD Network Forwarding | SS-SINR Synchronization Signal |
| | Path Descriptor | based Signal to Noise |
| | | and Interference Ratio |
| EEC Edge Enabler Client | NFV Network Functions | SSS Secondary |
| | Virtualization | Synchronization Signal |
| EECID Edge Enabler Client | NFVI NFV Infrastructure | SSSG Search Space Set |
| Identification | | Group |
| EES Edge Enabler Server | NFVO NFV Orchestrator | SSSIF Search Space Set |
| | | Indicator |
| EESID Edge Enabler Server | NG Next Generation, Next | SST Slice/Service Types |
| Identification | Gen | |
| EHE Edge Hosting | NGEN-DC NG-RAN E-UTRA- | SU-MIMO Single User MIMO |
| Environment | NR Dual Connectivity | |
| EGMF Exposure Governance | NM Network Manager | SUL Supplementary Uplink |
| tableManagement | | |
| Function | | |
| EGPRS Enhanced GPRS | NMS Network Management | TA Timing Advance, |
| | System | Tracking Area |
| EIR Equipment Identity | N-PoP Network Point of | TAC Tracking Area Code |
| Register | Presence | |
| eLAA enhanced Licensed | NMIB, N-MIB Narrowband MIB | TAG Timing Advance Group |
| Assisted Access, enhanced | | |
| LAA | | |
| EM Element Manager | NPBCH Narrowband Physical | TAI Tracking Area Identity |
| | Broadcast CHannel | |
| eMBB Enhanced Mobile | NPDCCH Narrowband Physical | TAU Tracking Area Update |
| Broadband | Downlink Control | |
| | CHannel | |
| EMS Element Management | NPDSCH Narrowband Physical | TB Transport Block |
| System | Downlink Shared | |
| | CHannel | |
| eNB evolved NodeB, E- | NPRACH Narrowband Physical | TBS Transport Block Size |
| UTRAN Node B | Random Access | |
| | CHannel | |
| EN-DC E-UTRA-NR Dual | NPUSCH Narrowband Physical | TBD To Be Defined |
| Connectivity | Uplink Shared | |
| | CHannel | |
| EPC Evolved Packet Core | NPSS Narrowband Primary | TCI Transmission |
| | Synchronization Signal | Configuration Indicator |
| EPDCCH enhanced PDCCH, | NSSS Narrowband | TCP Transmission |
| enhanced Physical | Secondary | Communication |
| Downlink Control Cannel | Synchronization Signal | Protocol |
| EPRE Energy per resource | NR New Radio, Neighbour | TDD Time Division Duplex |
| element | Relation | |
| EPS Evolved Packet System | NRF NF Repository | TDM Time Division |
| | Function | Multiplexing |
| EREG enhanced REG, enhanced | NRS Narrowband Reference | TDMA Time Division Multiple |
| resource element groups | Signal | Access |
| ETSI European | NS Network Service | TE Terminal Equipment |
| Telecommunications | | |
| Standards Institute | | |
| ETWS Earthquake and Tsunami | NSA Non-Standalone | TEID Tunnel End Point |
| Warning System | operation mode | Identifier |
| eUICC embedded UICC, | NSD Network Service | TFT Traffic Flow Template |
| embedded Universal | Descriptor | |
| Integrated Circuit Card | | |
| E-UTRA Evolved UTRA | NSR Network Service | TMSI Temporary Mobile |
| | Record | Subscriber Identity |
| E-UTRAN Evolved UTRAN | NSSAI Network Slice | TNL Transport Network |
| | Selection Assistance | Layer |
| | Information | |
| EV2X Enhanced V2X | S-NNSAI Single-NSSAI | TPC Transmit Power |
| | | Control |
| F1AP F1 Application Protocol | NSSF Network Slice | TPMI Transmitted Precoding |
| | Selection Function | Matrix Indicator |
| F1-C F1 Control plane interface | NW Network | TR Technical Report |
| F1-U F1 User plane interface | NWUS Narrowband wake-up | TRP, TRxP Transmission |
| | signal, Narrowband | Reception Point |
| | WUS | |
| FACCH Fast Associated Control | NZP Non-Zero Power | TRS Tracking Reference |
| CHannel | | Signal |
| FACCH/F Fast Associated Control | O&M Operation and | TRx Transceiver |
| Channel/Full rate | Maintenance | |
| FACCH/H Fast Associated Control | ODU2 Optical channel Data | TS Technical |
| Channel/Half rate | Unit - type 2 | Specifications, |
| | | Technical Standard |
| FACH Forward Access Channel | OFDM Orthogonal Frequency | TTI Transmission Time |
| | Division Multiplexing | Interval |
| FAUSCH Fast Uplink Signalling | OFDMA Orthogonal Frequency | Tx Transmission, |
| Channel | Division Multiple | Transmitting, |
| | Access | Transmitter |
| FB Functional Block | OOB Out-of-band | U-RNTI UTRAN Radio |
| | | Network Temporary |
| | | Identity |
| FBI Feedback Information | OOS Out of Sync | UART Universal |
| | | Asynchronous |
| | | Receiver and |
| | | Transmitter |
| FCC Federal Communications | OPEX OPerating EXpense | UCI Uplink Control |
| Commission | | Information |
| FCCH Frequency Correction | OSI Other System | UE User Equipment |
| CHannel | Information | |
| FDD Frequency Division | OSS Operations Support | UDM Unified Data |
| Duplex | System | Management |
| FDM Frequency Division | OTA over-the-air | UDP User Datagram |
| Multiplex | | Protocol |
| FDMA Frequency Division | PAPR Peak-to-Average | UDSF Unstructured Data |
| Multiple Access | Power Ratio | Storage Network |
| | | Function |
| FE Front End | PAR Peak to Average Ratio | UICC Universal Integrated |
| | | Circuit Card |
| FEC Forward Error Correction | PBCH Physical Broadcast | UL Uplink |
| | Channel | |
| FFS For Further Study | PC Power Control, | UM Unacknowledged |
| | Personal Computer | Mode |
| FFT Fast Fourier | PCC Primary Component | UML Unified Modelling |
| Transformation | Carrier, Primary CC | Language |
| feLAA further enhanced Licensed | PCell Primary Cell | UMTS Universal Mobile |
| Assisted Access, further | | Telecommunications |
| enhanced LAA | | System |
| FN Frame Number | PCI Physical Cell ID, | UP User Plane |
| | Physical Cell Identity | |
| FPGA Field-Programmable Gate | PCEF Policy and Charging | UPF User Plane Function |
| Array | Enforcement Function | |
| FR Frequency Range | PCF Policy Control | URI Uniform Resource |
| | Function | Identifier |
| FQDN Fully Qualified Domain | PCRFPolicy Control and | URL Uniform Resource |
| Name | Charging Rules | Locator |
| | Function | |
| G-RNTI GERAN Radio Network | PDCP Packet Data | URLLC Ultra-Reliable and Low |
| Temporary Identity | Convergence Protocol, | Latency |
| | Packet Data | |
| | Convergence Protocol | |
| | layer | |
| GERAN GSM EDGE RAN, GSM | PDCCH Physical Downlink | USB Universal Serial Bus |
| EDGE Radio Access | Control Channel | |
| Network | | |
| GGSN Gateway GPRS Support | PDCP Packet Data | USIM Universal Subscriber |
| Node | Convergence Protocol | Identity Module |
| GLONASS GLObal'naya | PDN Packet Data Network, | USS UE-specific search |
| NAvigatsionnaya | Public Data Network | space |
| Sputnikovaya Sistema | | |
| (Engl.: Global Navigation | | |
| Satellite System) | | |
| gNB Next Generation NodeB | PDSCH Physical Downlink | UTRA UMTS Terrestrial |
| | Shared Channel | Radio Access |
| gNB-CUgNB-centralized unit, Next | PDU Protocol Data Unit | UTRAN Universal Terrestrial |
| Generation NodeB | | Radio Access Network |
| centralized unit | | |
| gNB-DUgNB-distributedunit, Next | PEI Permanent Equipment | UwPTS Uplink Pilot Time Slot |
| Generation NodeB | Identifiers | |
| distributed unit | | |
| GNSS Global Navigation | PFD Packet Flow | V2I Vehicle-to- |
| Satellite System | Description | Infrastruction |
| GPRS General Packet Radio | P-GW PDN Gateway | V2P Vehicle-to-Pedestrian |
| Service | | |
| GPSI Generic Public | PHICH Physical hybrid-ARQ | V2V Vehicle-to-Vehicle |
| Subscription Identifier | indicator channel | |
| GSM Global System for Mobile | PHY Physical layer | V2X Vehicle-to-everything |
| Communications, Groupe | | |
| Special Mobile | | |
| GTP GPRS Tunneling Protocol | PLMN Public Land Mobile | VIM Virtualized |
| | Network | Infrastructure Manager |
| GTP-U GPRS Tunnelling Protocol | PIN Personal Identification | VL Virtual Link, |
| for User Plane | Number | |
| GTS Go To Sleep Signal | PM Performance | VLAN Virtual LAN, Virtual |
| (related to WUS) | Measurement | Local Area Network |
| GUMMEI Globally Unique MME | PMI Precoding Matrix | VM Virtual Machine |
| Identifier | Indicator | |
| GUTI Globally Unique | PNF Physical Network | VNF Virtualized Network |
| Temporary UE Identity | Function | Function |
| HARQ Hybrid ARQ, Hybrid | PNFD Physical Network | VNFFG VNF Forwarding |
| Automatic Repeat Request | Function Descriptor | Graph |
| HANDO Handover | PNFR Physical Network | VNFFGD VNF Forwarding |
| | Function Record | Graph Descriptor |
| HEN HyperFrame Number | POC PTT over Cellular | VNFM VNF Manager |
| HHO Hard Handover | PP, PTP Point-to-Point | VoIP Voice-over-IP, Voice- |
| | | over-Internet Protocol |
| HLR Home Location Register | PPP Point-to-Point Protocol | VPLMN Visited Public Land |
| | | Mobile Network |
| HN Home Network | PRACH Physical RACH | VPN Virtual Private |
| | | Network |
| HO Handover | PRB Physical resource | VRB Virtual Resource Block |
| | block | |
| HPLMN Home Public Land Mobile | PRG Physical resource | WiMAX Worldwide |
| Network | block group | Interoperability for |
| | | Microwave Access |
| HSDPA High Speed Downlink | ProSe Proximity Services, | WLAN Wireless Local Area |
| Packet Access | Proximity-Based | Network |
| | Service | |
| HSN Hopping Sequence | PRS Positioning Reference | WMAN Wireless Metropolitan |
| Number | Signal | Area Network |
| HSPA High Speed Packet Access | PRR Packet Reception | WPAN Wireless Personal Area |
| | Radio | Network |
| HSS Home Subscriber Server | PS Packet Services | X2-C X2-Control plane |
| HSUPA High Speed Uplink Packet | PSBCH Physical Sidelink | X2-U X2-User plane |
| Access | Broadcast Channel | |
| HTTP Hyper Text Transfer | PSDCH Physical Sidelink | XML eXtensible Markup |
| Protocol | Downlink Channel | Language |
| HTTPS Hyper Text Transfer | PSCCH Physical Sidelink | XRES EXpected user |
| Protocol Secure (https is | Control Channel | RESponse |
| http/1.1 over SSL, i.e. port | | |
| 443) | | |
| I-Block Information Block | PSSCH Physical Sidelink | XOR eXclusive OR |
| | Shared Channel | |
| ICCID Integrated Circuit Card | PSCell Primary SCell | ZC Zadoff-Chu |
| Identification | | |
| IAB Integrated Access and | PSS Primary | ZP Zero Po |
| Backhaul | Synchronization Signal | |
| ICIC Inter-Cell Interference | PSTN Public Switched | |
| Coordination | Telephone Network | |
| ID Identity, identifier | PT-RS Phase-tracking | |
| | reference signal | |
| IDFT Inverse Discrete Fourier | PTT Push-to-Talk | |
| Transform | | |
| IE Information element | PUCCH Physical Uplink | |
| | Control Channel | |

What is claimed is:

1. A user equipment (UE) device for receiving network-assisted multi-user multiple input multiple output (MU-MIMO) signaling, the UE device comprising processing circuitry coupled to storage for storing information associated with the MU-MIMO signaling, the processing circuitry configured to:
decode a MU-MIMO set-up field in a radio resource control (RRC) message sent from a Next Generation NodeB (gNB);
determine, based on at least two bits in the MU-MIMO set-up field, that a MU-MIMO transmission is enabled; and
determine, based on that least two bits, a modulation scheme for co-scheduled UE devices.

2. The UE device of claim 1, wherein the processing circuitry is further configured to, in response to determining that the MU-MIMO transmission is enabled:
configure first parameters on a demodulation reference signal and a physical downlink shared control channel (PDSCH) allocation, using second parameters of a second UE device, based on signaling by at least one of downlink control information (DCI) or the RRC message.

3. The UE device of claim 2, wherein the first parameters comprise a demodulation reference signal configuration, a scrambling identifier setting rule, and a precoding granularity.

4. The UE device of claim 2, wherein the first parameters comprise a same allocation region in at least one of time or frequency resources as the second UE device.

5. The UE device of claim 1, wherein the processing circuitry is further configured to:
decode port presence information and modulation orders of an interfering layer signaled in DCI fields.

6. The UE device of claim 5, wherein the DCI fields use a form of variable size depending on a maximum number of MIMO layers of a bandwidth part.

7. The UE device of claim 5, wherein the DCI fields comprise a field jointly representing interference presence, modulation order, and port location by cyclic ordering.

8. The UE device of claim 5, wherein the DCI fields correspond to two or more antennae ports of the UE device.

9. The UE device of claim 1, wherein the processing circuitry is further configured to:
detect a MU-MIMO scheduler flexibility defining a scheduler restriction as a maximum number of allowed resource allocation transitions per interfering layer.

10. A non-transitory computer-readable storage medium comprising instructions to cause processing circuitry of a user equipment (UE) device for receiving network-assisted multi-user multiple input multiple output (MU-MIMO) signaling, upon execution of the instructions by the processing circuitry, to:
decode a MU-MIMO set-up field in a radio resource control (RRC) message sent from a Next Generation NodeB (gNB);
determine, based on at least two bits in the MU-MIMO set-up field, that a MU-MIMO transmission is enabled; and
determine, based on that least two bits, a modulation scheme for co-scheduled UE devices.

11. The non-transitory computer-readable storage medium of claim 10, wherein execution of the instructions further causes the processing circuitry to, in response to determining that the MU-MIMO transmission is enabled:
configure first parameters on a demodulation reference signal and a physical downlink shared control channel (PDSCH) allocation, using second parameters of a second UE device, based on signaling by at least one of downlink control information (DCI) or the RRC message.

12. The non-transitory computer-readable storage medium of claim 11, wherein the first parameters comprise a demodulation reference signal configuration, a scrambling identifier setting rule, and a precoding granularity.

13. The non-transitory computer-readable storage medium of claim 11, wherein the first parameters comprise a same allocation region in at least one of time or frequency resources as the second UE device.

14. The non-transitory computer-readable storage medium of claim 10, wherein execution of the instructions further causes the processing circuitry to:
decode port presence information and modulation orders of an interfering layer signaled in DCI fields.

15. The non-transitory computer-readable storage medium of claim 14, wherein the DCI fields use a form of variable size depending on a maximum number of MIMO layers of a bandwidth part.

16. The non-transitory computer-readable storage medium of claim 14, wherein the DCI fields comprise a field jointly representing interference presence, modulation order, and port location by cyclic ordering.

17. The non-transitory computer-readable storage medium of claim 14, wherein the DCI fields correspond to two or more antennae ports of the UE device.

18. A method for receiving network-assisted multi-user multiple input multiple output (MU-MIMO) signaling, the method comprising:
decoding, by processing circuitry of a user equipment (UE) device, a MU-MIMO set-up field in a radio resource control (RRC) message sent from a Next Generation NodeB (gNB);
determining, by the processing circuitry, based on at least two bits in the MU-MIMO set-up field, that a MU-MIMO transmission is enabled; and
determining, by the processing circuitry, based on that least two bits, a modulation scheme for co-scheduled UE devices.

19. A non-transitory computer-readable storage medium comprising instructions to perform the method of claim 18.

20. An apparatus comprising means for performing the method of claim 18.
